(19) United States
(12) Patent Application Publication
(10) Pub. No.: US 2011/0213949 A1
(43) Pub. Date: Sep. 1, 2011

(54) METHODS AND APPARATUS FOR OPTIMIZING CONCURRENCY IN MULTIPLE CORE SYSTEMS

(75) Inventors: Doddaballapur N. Jayasimha, Sunnyvale, CA (US); Luc Hoa Ton, San Jose, CA (US); Drew E. Wingard, Palo Alto, CA (US)

(73) Assignee: SONICS, INC., Milpitas, CA (US)

(21) Appl. No.: 12/714,810

(22) Filed: Mar. 1, 2010

(51) Int. Cl. G06F 15/76; G06F 12/00; G06F 9/46

(52) U.S. Cl. 712/29; 711/108; 712/E09.016; 711/E12.001; 718/101

(57) ABSTRACT

Various methods and apparatus are described for communicating transactions between one or more initiator IP cores and one or more target IP cores coupled to an interconnect. Tag logic may be located within the interconnect, such as located in an agent, and configured to assign different interconnect tag identification numbers to two or more transactions from a same thread. The tag logic assigns different interconnect tag identification numbers to allow the two or more transactions from the same thread to be outstanding over the interconnect to two or more different target IP cores at the same time, allow the two or more transactions from the same thread to be processed in parallel over the interconnect, and potentially serviced out of issue order while being returned back to the multiple threaded initiator IP core realigned in expected execution order.

### NOTICE OF COPYRIGHT

A portion of the disclosure of this patent document contains material that is subject to copyright protection. The copyright owner has no objection to the facsimile reproduction by anyone of the software engine and its modules, as it appears in the Patent and Trademark Office Patent file or records, but otherwise reserves all copyright rights whatsoever.

### FIELD OF THE INVENTION

Embodiments of the invention generally relate to methods and apparatus for optimizing concurrency in multiple Intellectual Property core systems including target and initiator cores.

### BACKGROUND OF THE INVENTION

In integrated circuit, a limited amount of space to house the circuitry may exist in that integrated circuit. A tradeoff occurs between increasing an amount of transactions being processed over a given period of time and the increase in area occupied by the logic and buffering required to allow a higher amount of transactions being processed over a given period of time.

### SUMMARY OF THE INVENTION

Various methods and apparatus are described for communicating transactions between one or more initiator IP cores and one or more target IP cores coupled to an interconnect. Tag logic may be located within the interconnect, such as located in an agent, and configured to assign different interconnect tag identification numbers to two or more transactions from a same thread from a first multiple threaded initiator IP core. The tag logic assigns different interconnect tag identification numbers to improve overall system performance by allowing the two or more transactions from the same thread of a first multiple threaded initiator IP core to be outstanding over the interconnect to two or more different target IP cores at the same time. The tag logic is further configured to allow the two or more transactions from the same thread to be processed in parallel over the interconnect and potentially serviced out of issue order while being returned back to the first multiple threaded initiator IP core realigned in expected execution order. This eliminates any need for a re-order buffer per thread per initiator core. An interconnect tag identification number can be used to link a response to a transaction with a thread generating the transaction that triggered the response from a first target IP core.

### BRIEF DESCRIPTION OF THE DRAWINGS

The drawings refer to embodiments of the invention in which:

FIG. 1 illustrates a block diagram of an embodiment of a System-on-a-Chip having multiple initiator Intellectual Property (IP) cores and multiple target IP cores that communicate transactions such as read and write requests, burst requests, as well as responses to those transactions over an interconnect.

FIG. 2 illustrates tag logic for transactions on the interconnect. An initiator IP core may connect to the interconnect and interface with the interconnect through an initiator agent.

FIG. 3 illustrates a block diagram of an embodiment of a integrated circuit having multiple initiator IP cores and multiple target IP cores with tag logic assigning tag numbers for each thread per initiator IP core, and the interconnect that routes the transactions of those threads contains thread merger and thread splitter units.

FIG. 4 illustrates the Content Addressable Memory (CAM) portion of a possible embodiment of the structure of the crossover storage structure, containing the CAM and a shared buffer pool, which allows the interconnect to assign tags with a minimum amount of area and logic in the integrated circuit.

FIG. 5 illustrates the shared buffer pool portion of a possible embodiment of the structure of the crossover storage structure, containing the CAM and a shared buffer pool.

FIG. 6 illustrates logic for dynamic mapping of the tag space of a first component on the integrated circuit to the tag space of the bus interconnect of the integrated circuit.

FIG. 7 illustrates the tag logic that is configured to support different types of tags, including Compact Tags, Partially Compact Tags, Pass Through Tags with Init ID, and Pass Through Tags without Init ID to alter an allocation and a de-allocation operation of assigning internal interconnect tag id number to a thread from the crossover storage structure.

FIGS. 8a and 8b illustrate agent Request and Response Path Logic for each Tag Space Type.

FIGS. 9 and 10 illustrate the tag logic in the interconnect which allows tag assigning to be implemented in a multiple channel aggregate target IP core environment.

FIG. 11 illustrates a flow diagram of an embodiment of an example of a process for generating a device, such as a System on a Chip, with the designs and concepts discussed above for the Interconnect and Memory Scheduler.

FIGS. 12a and 12b illustrate thread collapsing logic within the interconnect in a system having one or more multiple channel target IP cores

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific data signals, named components, connections, number of memory channels in an aggregate target, etc., in order to provide a thorough understanding of the present invention. However, it will be apparent to a person of ordinary skill in the art that the present invention may be practiced without these specific details. In other instances, well known components or methods have not been described in detail, but rather in a block diagram in order to avoid unnecessarily obscuring the present invention. Further, specific numeric references, such as first target, may be made. However, the specific numeric reference should not be interpreted as a literal sequential order, but rather interpreted that the first target is different than a second target. Thus, the specific details set forth are merely exemplary. The specific details may be varied from, and still be contemplated to be, within the spirit and scope of the present invention.

In general, a method, apparatus, and system are described, which generally relate to an integrated circuit having an interconnect that has tag logic located within the interconnect to assign different interconnect tag identification numbers to two or more transactions from a same thread from a first multiple threaded initiator IP core. The tag logic may be configured to support dynamic mapping of one tag id space to another tag id space as a transaction moves through the interconnect to allow allocation and de-allocation of internal interconnect tag id numbering during the operation of the integrated circuit. An assigned internal interconnect tag id number is released for use again by the tag logic when a response, from a given target IP core, corresponding to a last outstanding transaction of a series of transactions associated with 1) a given thread ID and 2) the assigned internal interconnect tag id number issued by the initiator agent is received back by the initiator agent containing the tag logic that assigned the internal interconnect tag id number.

In addition, a transaction from a thread from an initiator IP core may be routed to a multiple channel aggregate memory target IP core, in which the transaction traffic consists of both non-channel-splitting requests and channel-splitting requests. The multiple channel aggregate memory target IP core includes two or more memory channels that populate an address space assigned to that multiple channel aggregate memory target IP core. The multiple channel aggregate memory target IP core appears as a single target to the one or more initiator IP cores. The tag logic may assign a first interconnect tag id number to a first transaction and a second interconnect tag id number to a second transaction from the same thread from a given initiator IP core being routed to the multiple channel aggregate memory target IP core. Next, the tag logic detects whether a request of the first transaction from the thread spans over at least a first and second memory channel in the multiple channel aggregate memory target IP core. If so, the tag logic applies interlocks so that in terms of correctness, all of the responses of the first transaction and second transaction are routed back across the interconnect to the first initiator IP core in the expected execution order.

Most aspects of the invention may be applied in most networking environments and an example integrated circuit such as a System-on-a-Chip environment will be used to flush out these aspects of the invention.

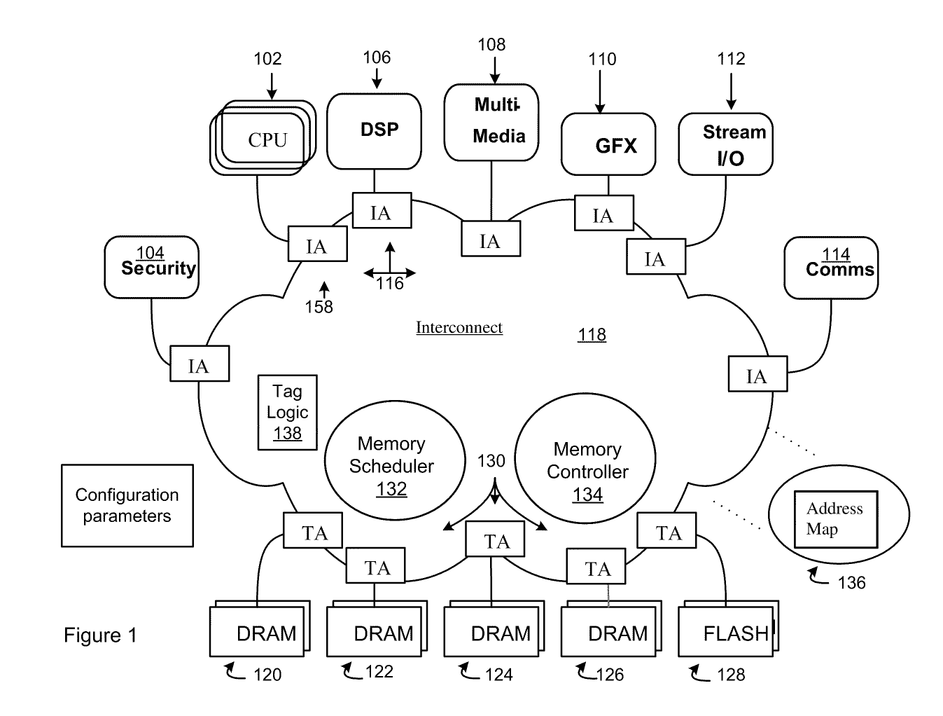

FIG. 1 illustrates a block diagram of an embodiment of a System-on-a-Chip having multiple initiator Intellectual Property (IP) cores and multiple target IP cores that communicate transactions such as read and write requests, burst requests, as well as responses to those transactions over an interconnect. Each initiator IP core such as a CPU IP core 102, an on-chip security IP core 104, a Digital Signal Processor (DSP) 106 IP core, a multimedia IP core 108, a Graphics IP core 110, a streaming Input-Output (I/O) IP core 112, a communications IP core 114, such as a wireless transmit and receive IP core with devices or components external to the chip, etc. and other similar IP cores may have its own initiator agent 116 to interface that IP core to the remainder of the interconnect 118. Each target IP core, such as a first DRAM IP core 120 through a fourth DRAM IP core 126 as well as a FLASH memory IP core 128, may have its own target agent 130 to interface that IP core to the remainder of the interconnect 118. Each DRAM IP core 120-126 may have an associated memory scheduler 132 as well as DRAM controller 134.

The IP cores have self-contained designed functionality to provide that macro function to the system. For example, initiator property cores Central processing unit 102, multi-media core 108, communication core 114 all have logic and software configured to provide that macro function to the interconnect. Likewise, target IP core Dynamic random access memory (DRAM) 126 provides that function to the system. The interconnect 118 implements an address map 136 with assigned address for the target IP cores 120-128, and potentially the initiator IP cores 102-114 in the system to route the requests, and potentially responses between the target IP cores 120-128 and initiator IP cores 102-114 in the integrated circuit. Most of the distinct IP cores communicate to each other over the interconnect 118 as well as through the memory IP cores 120-126, on and off chip. The DRAM controller 134 and address map 136 in each initiator agent 116 and target agent 130 abstracts the real IP core addresses of each DRAM IP core 120-126 from other on-chip cores by maintaining the address map and performing address translation of assigned logical addresses in the address map to physical IP addresses.

The address mapping hardware logic may also be located inside an initiator agent. The DRAM scheduler 132 and controller 134 may be connected downstream of a target agent or located within the interconnect 118. Accordingly, one method for determining the routing of requests from initiators to targets is to implement an address mapping apparatus that associates incoming initiator addresses with specific target IP cores.

The interconnect 118 provides a shared communications fabric, such as a bus, between IP core sub-systems 120-128 and 102-114 of the system. All the communication paths in the shared communication fabric need not pass through a single choke point, rather many distributed pathways may exist in the shared communication fabric. The on-chip interconnect 118 may be a collection of mechanisms that may be adapters and/or other logical modules along with interconnecting wires that facilitate address-mapped and arbitrated communication between the multiple Intellectual Property cores 102-114 and 120-128.

The interconnect 118 may be part of an integrated circuit, such as System-on-a-Chip, that is pipelined with buffering to store and move requests and responses in stages through the System-on-a-Chip. The interconnect 118 may be part of an integrated circuit, such as System-on-a-Chip, that is pipelined with buffering to store and move requests and responses in stages through the System-on-a-Chip. The interconnect 118 may have flow control logic that 1) is non-blocking with respect to requests from another thread, as well as with respect to requiring a response to an initial request before issuing a subsequent request from the same thread, 2) implements a pipelined protocol, and 3) maintains each thread's expected execution order. The interconnect 118 also may support multiple memory channel modules in a single aggregate target, with 2D and address tiling features, response flow control, chopping of individual burst requests, and distribution of requests headed to that aggregate target in either a linear or non-linear sequential pattern in channel round order. Each initiator IP core may have its own initiator agent to interface with the interconnect. Each target IP core 120-128 may have its own target agent 130 to interface with the interconnect 118.

A target core, such as an OCP slave, should normally return responses to request transactions made by the initiator core, such as an OCP master, in the same order in which the requests were issued by the OCP master. However, sometimes it makes more sense for the OCP slave to return serviced responses out of their expected order to the OCP master and let tag logic 138 in the interconnect 118 to handle the ordering of the transaction. Tag identification numbers can be used to directly link the response with the original thread generating the transaction request that triggered the response from the OCP slave. In many cases, the use of tag logic 138 within the interconnect 118, such as located in an agent 116, 130, assigns tags to improve overall system performance by allowing multiple transactions from the same thread of a multiple threaded initiator IP core to be outstanding over the interconnect 118 to two or more different target IP cores 120-128 at the same time.

An multiple threaded initiator IP core, such as CPU 102, may generate a thread of related transactions. The tag logic 138 allows the transactions to be tagged, and, on the basis of that tag, to be treated differently. This allows for data flows from different initiator IP cores/masters or even different threads from the same initiator IP core to be identified by the target/slave cores, and thus, facilitates differential quality of service to distinct data streams and often improves performance by allowing transaction reordering to suit a specific instance of the subsystem's timing constraints (e.g. in DRAM controllers). Tag ids for transactions from same thread allows multiple transactions (burst requests, requests, etc) from same source to be outstanding/processed in parallel while minimizing dedicated buffer space and logic per thread. A multiple threaded initiator IP core uses threads to have multiple transactions processed in parallel. However, the combination of the tag logic 138 assigning various interconnect tag identification numbers to transactions from the same thread for one or more of the independent thread steams allows multiple transactions processed in parallel with a minimum or at least lower amount of dedicated storage space area and logic per thread occupied on the integrated circuit to allow the initiator transactions to be processed both in parallel and potentially serviced out of issue order while being returned back to the initiator IP core realigned in expected execution order and eliminates any need for a re-order buffer per thread per initiator core. Tags can be thought of as being more “lightweight” than threads for providing out-of-order responses from the target core while ensuring that the response is returned back to the initiator IP core realigned in expected execution order. In particular, multiple threads provide independent flow control for each thread, while tags use a single shared flow of control for all tags. Also, the tag logic 138 is further configured to apply no ordering rules for transactions on different threads, while regulating that certain transactions with an assigned given internal interconnect tag id number from the same thread cannot be re-ordered or be allowed to be serviced before other interconnect tag id numbers when headed to the same target IP core. Finally, independent buffering is required for each thread, while shared buffering requirements for tags can occur since the flow control is shared between all tags. Also, most major protocols currently do not have a flow control mechanism set out for tag related transaction flows unlike established transaction flows for threads.

Each memory channel module may be an IP core or multiple external DRAM chips ganged together to act as a single aggregate memory to match the width of a data word such as 64 bits or 128 bits. Each memory IP core and DRAM chip may have multiple banks inside that IP core/chip. Each channel in a memory channel module may contain one or more buffers that can store requests and/or responses associated with the channel. These buffers can hold request addresses, write data words, read data words, and other control information associated with channel transactions, and can help improve memory throughput by supplying requests and write data to the memory, and receiving read data from the memory, in a pipelined fashion. The buffers can also improve memory throughput by allowing a memory scheduler to exploit address locality to favor requests that target a memory page that is already open, as opposed to servicing a different request that forces that page to be closed in order to open a different page in the same memory bank.

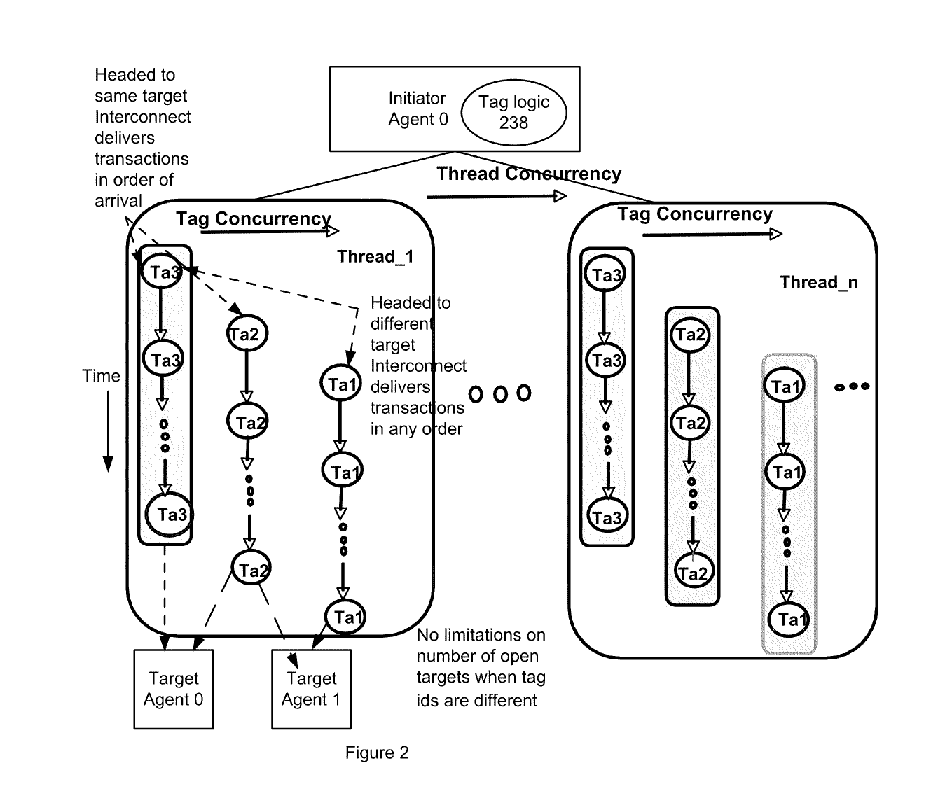

FIG. 2 illustrates tag logic for transactions on the interconnect. An initiator IP core may connect to the interconnect and interface with the interconnect through an initiator agent. The tag logic 238 may be located in an initiator agent, such as initiator agent 0. The transactions for the threads from the multiple threaded initiator, such as thread 1 and thread N, are assigned tag IDs by the tag logic 238 in the initiator agent. The tag logic 238 is configured to apply no ordering rules for transactions on different threads, while regulating that certain tagged transactions from the same thread cannot be re-ordered or be allowed to be serviced before other tags. The tag logic 238 is configured to allow multiple transactions with the same thread id but different interconnect tag id numbers, such as Tag1 and Tag 3 of thread 1, bound to different target agents, such as Target agent 0 and Target agent 1 can exit the interconnect in any order. The tag logic 238 is configured for multiple transactions with the same thread id but different interconnect tag id numbers headed to the same target IP core, such as Tag 2 and Tag 3 of thread 1 headed to Target agent 0, then the interconnect delivers those two transactions to the same target IP core in the order of arrival that those two transactions were launched onto the interconnect. For example, the transaction with the assigned tag 2 ID number would be delivered to target agent 0 before the transaction with the assigned tag 3 ID because according to the time line tag 2 was first launched onto the interconnect. Thus, two transactions (same thread id) bound to same target agent are delivered to the target IP core in their order of arrival at the initiator agent interface to the interconnect. The tag logic 238 is configured to have no limitations on the number of open targets when tag ids from the same thread of the same initiator are different. Thus, tag ID numbers tag 1-tag 3 can all be pending on the interconnect at the same time when all three tags are headed to different targets. The tag logic 238 is configured to require multiple transactions belonging to the same initiator tag id to have the responses for those transactions come back to an initiator agent in issuance order. The tag logic 238 is configured to have transactions from the same thread with the same assigned tag IDs, such as tag 2, headed to different targets with to have no order among transactions exiting interconnect. Initiator agent can have transactions from same thread with different tags outstanding to same target open on each tag, and thus, tag 3 and tag 2 can be issued onto the interconnect and outstanding at the same time. Note, there are no ordering rules for transactions on different threads, such as Thread 1 and thread N, while as just discussed certain tagged transactions cannot be re-ordered or be allowed to be serviced before other tags for transactions from the same thread. The above tag logic 238 avoids response re-ordering buffers in the initiator agent and/or target agent and the buffer's control logic to handle out-of-order returns.

The transaction launch order may be as follows. A transaction is said to be launched from the initiator IP core when the first transfer of that transaction enters the interconnect fabric and the corresponding command queue entry is cleared.

The tag logic 238 within the interconnect, such as located in an initiator and/or target agent, assigns tags to improve overall system performance by allowing multiple transactions from the same thread of a multiple threaded initiator to be outstanding over the interconnect to two or more different targets at the same time. The tag id numbers for transactions from same thread allows multiple transactions (burst requests, requests, etc) from same source to be outstanding/processed in parallel while minimizing dedicated buffer space and logic per thread.

Additionally, tagged transactions are not explicitly reprioritized by the interconnect, rather just restrictions on the flow through the interconnect for some of those tagged transactions exist. The architecture does not impose any restriction on the connectivity between tagged or untagged initiators and targets. To simplify the implementation and verification, the architecture treats an untagged interface as a single tag interface, internally.

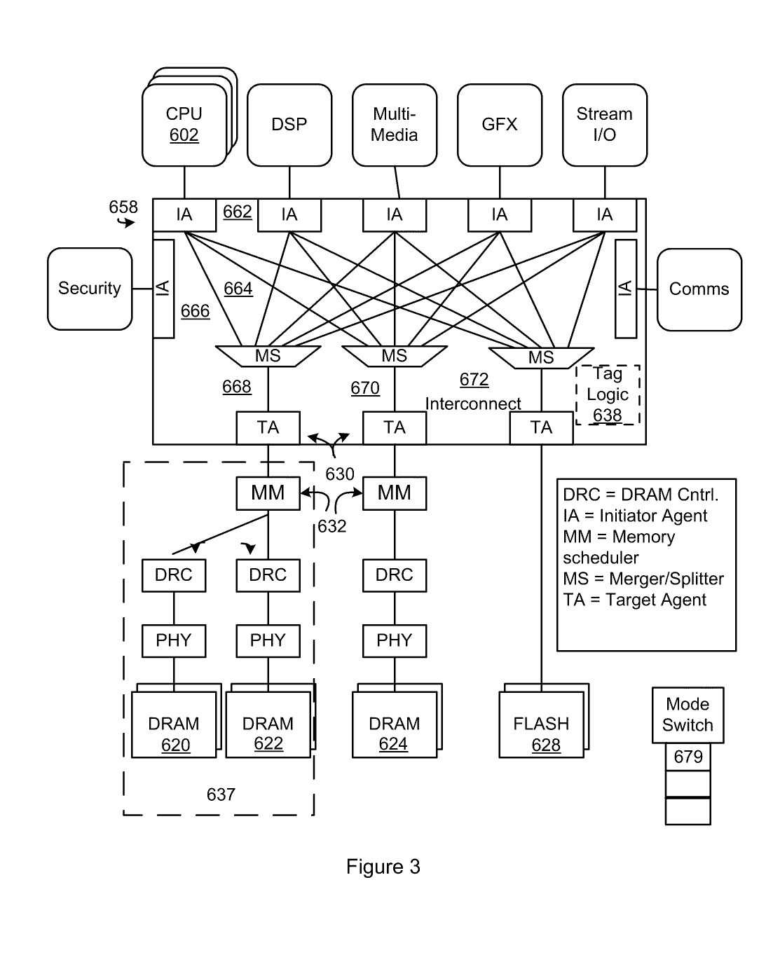

FIG. 3 illustrates a block diagram of an embodiment of a integrated circuit having multiple initiator IP cores and multiple target IP cores with tag logic assigning tag numbers for each thread per initiator IP core, and the interconnect that routes the transactions of those threads contains thread merger and thread splitter units.

Each initiator IP core, such as a Central Processor Unit IP core 602, may have its own initiator agent 658 to interface with the interconnect 618. Each target IP core such as a first DRAM IP core may have its own initiator agent to interface with the interconnect 618. Each DRAM IP core 620-624 may have an associated memory scheduler 632, DRAM controller 634, and PHY unit 635. The interconnect 618 implements flow control logic internal to the interconnect 618 itself to manage an order of when each issued request in a given thread arrives at its destination address for each thread on a per thread basis. The first target DRAM IP core 620 and the second target DRAM IP core 622 may be a multiple channel aggregate target IP core 637 with defined memory interleave segments.

With tag logic 638, no reorder buffer per thread is needed in each initiator agent 662 and target agent 630. In some instances of tag logic 638, no FIFO buffer per thread for every thread of the initiator exists. Instead with the tag logic 638, a CAM (content addressable memory) and shared pool exists or if not the CAM, maybe a set number of FIFOs per initiator, rather than per thread, along with a shared storage structure for overflow threads. The tag logic 638 in the interconnect 666 internally tracks an issuance order of transactions, such as burst request or requests, from a given thread of a given IP core and assigns an interconnect tag id number for all transactions of that given thread that must be received back to that given IP core in their expected return order. Another thread from the same initiator is treated independently from the first thread. Different tags from the same thread may have some inter-relationships.

Different Tag ID Spaces are created in the integrated circuit. As a transaction moves from an OCP initiator to an OCP target on the request path and vice versa on the response path, the transaction logically crosses forwards and backwards over several tag id spaces. A few example tag id spaces as defined below.

1. The initiator tag id space corresponds to a tag id assigned by an initiator IP core, such as CPU 602. The initiator IP core tag id (itag id) space may include: tag id values at the initiator IP core as defined by the tags parameter. Initiator IP core tag id values can be wide in possible range value but are typically sparsely populated.

2. Interconnect tag id (xtag id) space may include: tag id values that are tracked and assigned to threads being launched onto the interconnect by logic within the interconnect. In an embodiment, the interconnect tag id (xtag id) space may correspond to the indexes of the crossover storage structure (specifically the CAM at the agent) which get passed through the interconnect fabric via a tag id signal. The tag logic 638 may assign the interconnect tag id.

There is a logical and dynamic tag id mapping from one tag id space to another as a transaction moves onto, off of, and through the interconnect 666. For example, an initiator tag id can be dynamically mapped to an interconnect tag id. This means: an OCP transaction with itag id x can be mapped to an xtag id y and a later transaction with the same itag id x can be mapped to different xtag id z. Typically, the xtag id has a compact binary representation.

Additional tag ID spaces may include the following.

3. The target interconnect tag id (target xtag id) space may include: tag id values that are the indexes of the target agent crossover storage structure (specifically the CAM at the target agent 630). In this embodiment, both the target agent and initiator agent may issue tag ids assigned by instances of tag logic 638 that have values which are defined on a per-thread basis.

An incoming interconnect tag id (on the request path) can be dynamically mapped to a target interconnect tag id. In an embodiment, an interconnect tag id (xtag id) that corresponds to an index value of the initiator agent crossover storage structure is mapped to a target interconnect tag id that corresponds to an index value of the target agent crossover storage structure.

This also means: a DL transaction with xtag id x can be mapped to a ‘target xtag id’ y and a later transaction with the same xtag id can be dynamically mapped to different ‘target xtag id’ z. Typically, the ‘target xtag id’ has also a compact binary representation.

4. Target IP core tag id (ttag id) space: tag id values at the Target IP core, such as memory scheduler 632, as defined by the tags parameter.

In an embodiment, the interconnect tag id value is the index of the initiator agent crossover storage structure CAM, while the ‘target xtag id’ value is the index of the target agent crossover storage structure CAM structure.

The tag space is sparsely populated if only a few tag ids from this range are used simultaneously (i.e., associated with transactions which are outstanding). On the other hand, if most of the tag ids from this range are simultaneously used, then the tag space is compact. The range of assignable tag numbers 0 to (2ⁿ−1) is called the tag space, where n be the number of tag id bits.

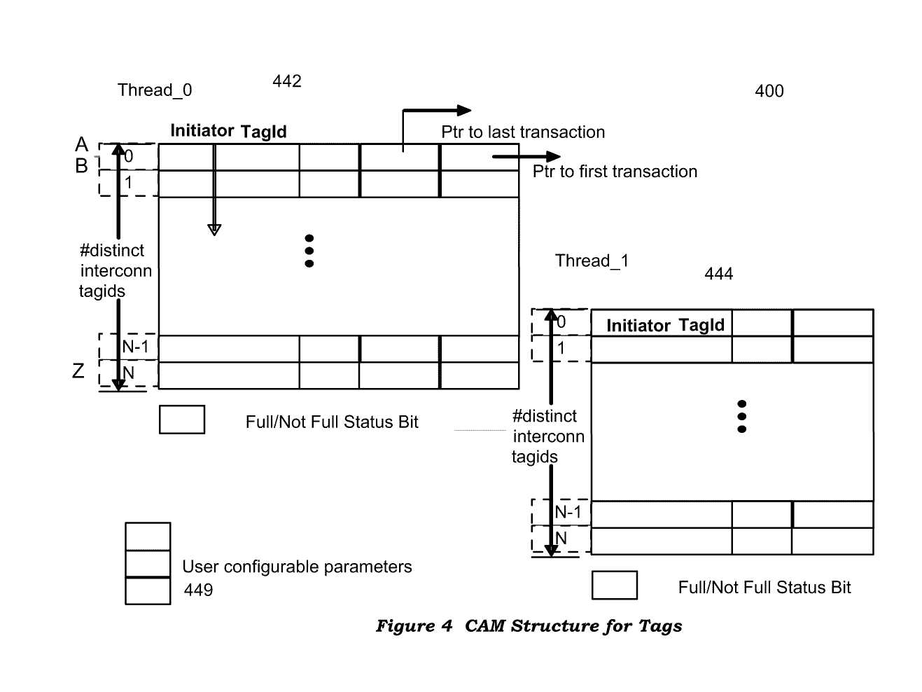

FIG. 4 illustrates the Content Addressable Memory (CAM) portion of a possible embodiment of the structure of the crossover storage structure, containing the CAM and a shared buffer pool, which allows the interconnect to assign tags with a minimum amount of area and logic in the integrated circuit. Independent buffering is required for each thread, while shared buffering requirements for tags can occur since the flow control is shared between all tags. An embodiment of the crossover storage structure architecture 400 uses two primary data structures—the “CAM” 440 and a shared “Buffer Pool”. Instances of a crossover storage structure making up part of the tag logic may exist on both the target agent side of the interconnect and the initiator agent side of the interconnect in each agent. An instance of the CAM structure 442 and 444 may exist for each different thread, such as thread_0 and thread_1, being assigned interconnect tag id numbers.

Referring to the first CAM instance 442, horizontally, each CAM entry row A-Z represents an interconnect tag id number 0 through N that is potentially assigned to a currently outstanding transaction on the interconnect. The amount of horizontal rows/entries of the CAM is sized by a user programmable parameter. Each entry row of the CAM has many distinct fields including 1) an initiator IP core tag ID field, 2) interconnect tag ID field, 3) a first pointer, 4) a second pointer, and other similar fields. The initiator IP core tag ID field tracks a tuple of <an initiator IP core tag id and a thread id> associated with a series of transactions that share the same initiator IP core tag id and thread id. The interconnect tag ID field tracks an internal interconnect tag id assigned to the tuple of the initiator IP core tag id and a thread id. The interconnect tag ID field may also be the CAM entry index value. At each non-empty location, the CAM 442, 444 stores at least the initiator tag id and two pointers. The first pointer points to an initial outstanding transaction of the series with the assigned internal interconnect tag id number from that tuple. The second pointer points to a last outstanding transaction of the series with the assigned internal interconnect tag id number from that tuple. The initiator tag id is a searchable field for the CAM—this field can be used to regenerate the STag id for the OCP response phase at the initiator agent. In addition, the CAM structure 442, 444 has a full/not full status bit. Full indicates that the CAM is full, i.e., the number of distinct tag ids in the CAM is equal to the amount supplied by the user programmable parameter. The CAM structure 442, 444 may also have a burst field that stores a number of responses that still need to be generated for an outstanding burst transaction being tracked with the first internal interconnect tag id. Each CAM entry row contains at least pointers to the corresponding Buffer Pool entries to effectively create a linked list of Buffer Pool entries of tracked transactions per assigned internal interconnect tag id number and thus a linked list of transactions belonging to the same tag id without limiting the number of transactions per tag id.

As discussed in an embodiment, the interconnect tag id can carry the index entry number of the initiator agent CAM which has details of this transaction. The CAM entry index (initiator agent side) makes the cross over queue 400 size dependent on the number of outstanding transactions (per thread) at the initiator agent (or target agent). Thus, the cross over queue 400 may have just one entry for each transaction

The tag logic may include one or more instances of the crossover storage structure, each consisting of at least the CAM structure and the shared buffer pool structure, to allow assigning interconnect tag identification numbers with minimum area and logic because shared buffering of transactions with different interconnect tag identification numbers as well as different initiator IP core tag identification numbers occurs within the crossover storage structure 400.

In one sense, the cross over queue is viewed as a queue of size n with a FIFO buffer consisting of head, tail, and (n−2) entries. The fields in the head (response side) and the tail (request side) are updated (incremented or decremented). The fields in the other entries (n−2) entries of the FIFO do not change. The example contents of the fields may be:
DIFF field: Used for burst request transactions. The DIFF field holds the number of responses that still need to be generated for this burst transaction. This field is potentially updated on BOTH the request (tail) and response (head) sides when there is a single entry for this tag.
DEALLOC field: A Boolean flag which signifies if all the transfers of an incoming transaction have been accepted at the initiator agent. This is only updated once on the request side (tail). The DEALLOC field is used primarily for burst request transactions to assist in tracking when the first and last portion of the transaction associated with a given initiator tag id are completed.
Deallocation Condition: The condition for deallocating a cross over queue entry at the initiator agent that signifies the completion of the transaction from the interconnect's perspective.
p_ocpburstlast: An additional payload signal generated at the request side for use by the interconnect. This signal is set for the last request phase transfer, irrespective of the burst chopping. This signal is turned over by the cross over queue on the target agent side and returned on the response side in the internal interconnect.
p_ocprowlast: An additional payload signal generated at the request side for BLCK bursts. This signal is set for the last request phase transfer of a row in a BLCK burst, irrespective of the burst chopping. This signal is turned over by the cross over queue on the target agent side and returned on the response side in the internal interconnect.

Thus, a field in the CAM tracks the initiator IP core tag id and thread id, the CAM index field tracks the internal interconnect tag assigned to a thread, and logic is configured to dynamically map the CAM index field to the current associated tuple of initiator IP core tag id and thread id. Feedback logic from the response path that uses the fields of the CAM is used to free up the entry row of the CAM when the response from the target associated with the last transaction of a series of transactions associated with a given thread ID and tag ID issued by the initiator agent is received back by the initiator agent.

The fields of the CAM 442, 444 may also keep track of the issue order in which transactions of each particular thread using that CAM issue onto the interconnect. Logic in the interconnect tracks expected execution order of transactions issued from the same thread by assigning the same interconnect tag ID number to transactions from that thread, with the same initiator IP core tag, which need the response to the transaction to be returned to the initiator in the same order that they were issued in. The active transactions with the TagInOrder bit set are mapped to the same interconnect tag id (i.e., the same CAM entry) at each target agent. Thus, such transactions are sequentialized and the semantics of “taginorder” are maintained. Thus, the logic in the interconnect internally tracks the issuance order of transactions, such as burst request or requests, from a given thread and assigns a tag ID number for all transactions of that thread that must be received back in their expected return order.

On the request path from the initiator agent to the target, insertion into the CAM structure 442, 444 is based on the initiator IP core tag id (itag id). Upon receiving a new transaction the CAM 442, 444 stores the tuple of <initiator thread id, initiator IP core tag id> associated with the new transaction as a new CAM entry when a matching active tuple is not already stored in another CAM entry row. The tuple may be used as a search word. On the response path back into the initiator agent, deallocation from the CAM 442, 444 is based on the interconnect tag id and the interconnect tag id corresponds to an index into the CAM 442, 444 and, hence, is fast.

The CAM structure 442, 444 is indexed by interconnect tag id (interconnect tag id hereafter), and sized by interconnect_tags[threadid], which is user-specified. Each CAM entry represents an outstanding interconnect tag id. The interconnect_tags[threadid] setting in essence allows the user to specify the maximum number of distinct interconnect tag ids per thread that can be active at one time. In general, if a request needs a new CAM entry but the CAM is full, the request will be blocked until an entry frees up. Any OCP transaction with MTaglnOrder asserted during simulation will use the last entry in the CAM, thus serializing these transactions.

The logic in the target agent ensures that transactions originating from different sources (read “source” as initiator agent/initiator agent thread pair) going to a given target thread will map to different ‘target xtag id’ values, thereby ensuring maximum tagged transaction concurrency (remember that the ‘target xtag id’ value is the index of the target agent crossover storage structure CAM). The target agent/target agent derivation code constructs a static lookup table that maps from transaction source (initiator agent/initiator agent thread) to an xtag id prefix, where all prefixes of a given table are unique. This table is then used to differentiate the incoming requests' p_xtag id values and thus ensuring optimal tagged transaction concurrency.

An instance of a target agent crossover storage structure, like the initiator agent crossover storage structure, is configured as follows:

a. In an embodiment, one instance of the crossover storage structure exists per thread. Each crossover storage structure consists of a CAM structure and a Buffer Pool structure. An instance of the crossover storage structure can exist at both the target agent side of the interconnect and the initiator agent side of the interconnect.

b. The CAM structure is indexed by ‘target xtag id’ and sized by the target agent's interconnect_tags[threadid] value, which is user-specified. ‘Target xtag id’ is different from xtag id as the latter represents the interconnect tag id coming from/going to the interconnect fabric in the request/response path. Target_xtag id', however, is a localized target agent interconnect tag space that is defined, as afore mentioned, by the target agent's interconnect_tags[threadid] value. This implies a dynamic mapping from the interconnect tag id to ‘target xtag id’ on the request path and vice-versa on the response path.

i. If the target has taginorder enabled on its OCP interface, the size of the crossover storage CAM structure (for all target agent threads) must be interconnect_tags[threadid]+1. The one extra entry is reserved for interconnect transactions with p_taginorder asserted. That is, any interconnect transaction with p_taginorder asserted will unconditionally use the last entry in the CAM.

Note: This implementation implies that in-order transactions coming from multiple initiator agents will use the same target agent CAM entry, resulting in serialization of those transactions. An alternate solution would be to add an additional entry at the bottom of the CAM per connected initiator agent (with taginorder enabled), and ensure that transactions from these initiator agents use the appropriate reserved CAM entry.

The Buffer Pool structure is sized by the target agent's max_trans[threadid] value, which is user-settable.

c. To tie the CAM and Buffer Pool structures together, each CAM entry contains (among other things) pointers to the corresponding Buffer Pool entries to effectively create a linked list of Buffer Pool entries (i.e. one linked list of transactions per target interconnect tag).

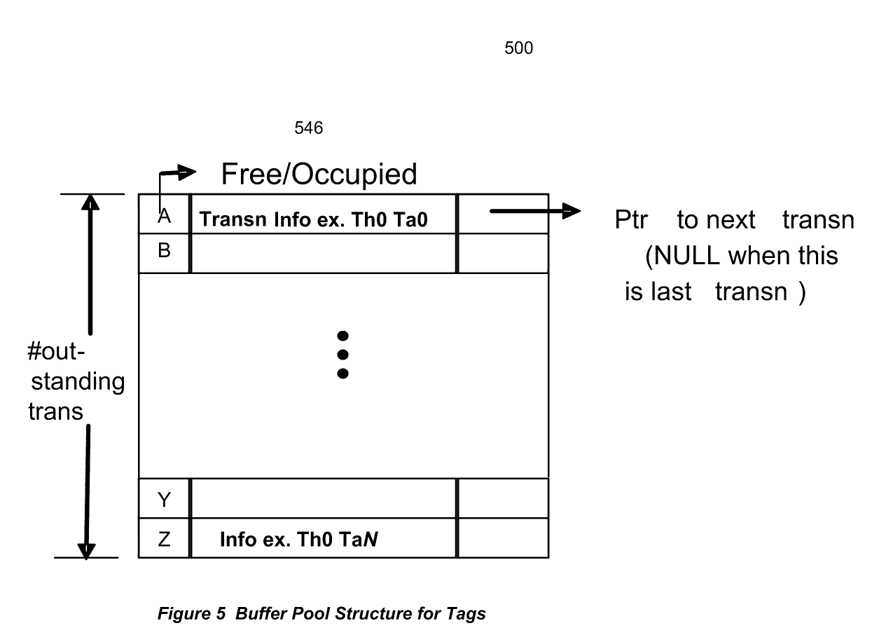

FIG. 5 illustrates the shared buffer pool portion of a possible embodiment of the structure of the crossover storage structure, containing the CAM and a shared buffer pool. As discussed, the agent crossover storage structure 500 is implemented as a combination of a CAM structure and a Buffer Pool structure 546. The shared buffer pool structure 546 makes the CAM-based crossover structure size dependent on the number of outstanding OCP transactions/per thread at the initiator agent (or target agent). The Buffer Pool structure 546 is sized by a user programmable parameter, such as #trans.

Horizontally, each row of the shared buffer pool structure 546 has many distinct fields including fields to store the assigned interconnect tag ID number, the thread ID, outstanding transactions of the threads using this agent, pointers to a next transaction, and whether this transaction is a last transaction in the sequence. The interconnect tag ID and thread ID can be stored in a field in the shared buffer pool. The outstanding transactions of the threads using this agent can be stored in another field. Pointers to the next transaction and whether this transaction is the last in the sequence can also be stored. Each non-empty location, indicated by the full/empty bit, stores the transaction information, and a pointer which points to the next in order transaction awaiting a response or is null if this the last transaction associated with that tuple of initiator thread ID and Initiator IP Core tag id. The amount of horizontal rows/entries of the shared buffer pool is sized by a user programmable parameter. The crossover storage structure uses the CAM and Buffer Pool structures to essentially create a link list of transactions belonging to the same tag id without limiting the number of transactions per tag id.

As discussed, the Buffer Pool structure 546 is sized by max_trans[threadid], which is user-settable. Each Buffer Pool entry represents an outstanding transaction (including burst transactions). Hence, the max_trans[threadid] setting allows the user to specify the maximum number of transactions per thread that can be active on the interconnect from that agent at any given point in time (across all tags on that thread). Note parameters let the user size the initiator agent crossover storage structure in terms of OCP transactions.

To tie the CAM and Buffer Pool structures together, each CAM entry contains (among other things) pointers to the corresponding Buffer Pool entries to effectively create a linked list of Buffer Pool entries (i.e., one linked list of transactions per interconnect tag).

One crossover storage structure exists per OCP thread. Each crossover storage structure consists of a CAM structure and a Buffer Pool structure. The CAM-based crossover storage structures, instead of FIFOs, handle out-of-order return of tagged responses for transactions. Rather than a CAM structure and shared buffer configuration, the cross over queue structure could also use some storage structure of a set number of dedicated FIFO buffers per initiator and active threads from that initiator exceeding the set number must use some set of shared FIFO buffers.

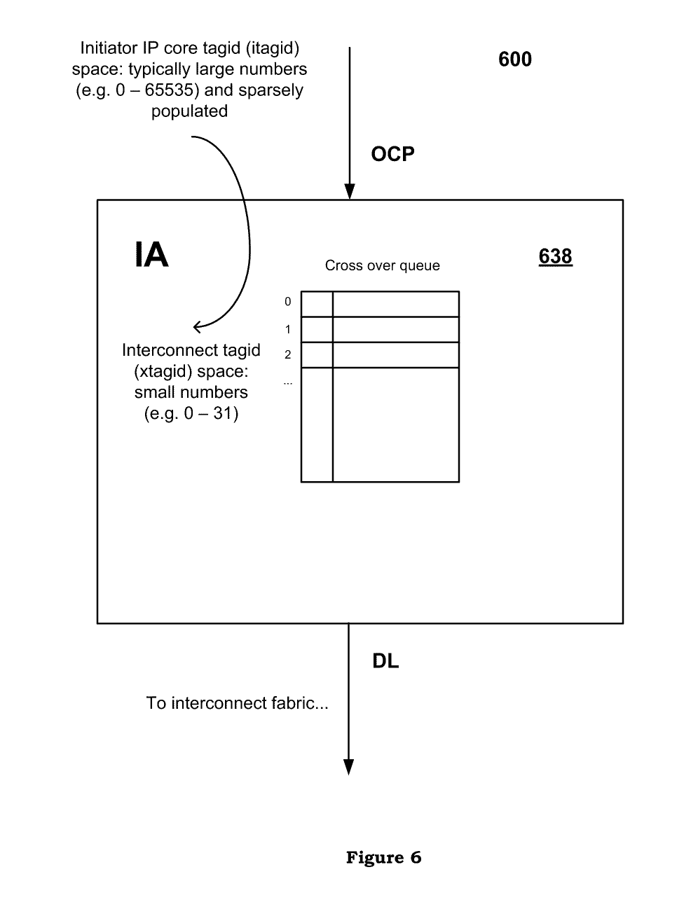

FIG. 6 illustrates logic for dynamic mapping of the tag space of a first component on the integrated circuit to the tag space of the bus interconnect of the integrated circuit. This is a simple diagram that depicts the dynamic mapping 600 from the tag space of a first component on the integrated circuit to the tag space of the bus interconnect of the integrated circuit. For example, an instance of the logic 638 facilitates the dynamic mapping of wide in range but sparse in amount of initiator IP core generated OCP tag ids to compact interconnect tag ids. The use of the CAM within the interconnect dynamically and efficiently maps the external initiator IP core tag space to the internal interconnect tag space, each stored in a field in the CAM.

Thus, the external initiator IP core tag id (itag id) space may be mapped to the internal interconnect tag id (xtag id) space. Note that the itag id is typically what the user cores send into the interconnect, and the xtag id is what is used internally to size the agent crossover storage structure.

This idea allows for the external tag space to be utilized however the system requires (e.g. often a large number of tags that are sparsely populated) while still using resources efficiently to achieve the required transaction concurrency.

The tag logic 638 located within the interconnect is configured to support dynamic mapping of one tag id space to another tag id space as a transaction moves through the interconnect to allow allocation and de-allocation of internal interconnect tag numbering during the operation of the integrated circuit, where an assigned internal interconnect tag id number is released for use again by the tag logic 638 when a response from a given target IP core corresponding to a last outstanding transaction of a series of transactions associated with 1) a given thread ID and 2) the assigned internal interconnect tag number issued by the initiator agent is received back by an initiator agent containing the tag logic assigning the internal interconnect tag id number.

There is a logical and dynamic tag id mapping 600 from one tag id space to another as a transaction moves through the interconnect. The tag logic 638 allows allocation and de-allocation of internal interconnect tag numbering during the operation of the device. Low area/improved timing is achieved by the CAM based organization with an index based mechanism for fast lookup on the response path.

The CAM (content addressable memory) within the interconnect makes dynamic runtime mapping of tag id numbers from the often larger, sparsely populated OCP initiator IP block tag space to the much more compact tag id numbers of the interconnect tag space. It is this mapping that allows OCP Tags to be implemented within the interconnect efficiently in terms of gate count as well as timing.

Adding OCP Tags support to interconnects allows a designer to utilize “tagged transaction concurrency” as defined in the OCP Specification (out-of-order return of responses and out-of-order commit of write data) while taking advantage of the interconnect technology to maximize overall system performance with efficient usage of resources.

As discussed, the mapping from itag id space to xtag id space is dynamic. For example, an incoming transaction with itag id of 29383 can be mapped to an xtag id of 0 at time X, but another transaction with the same itag id of 29383 can be mapped to an xtag id of 5 at time Y. This mapping is performed automatically by the tag logic 638 in the agent as each transaction arrives.

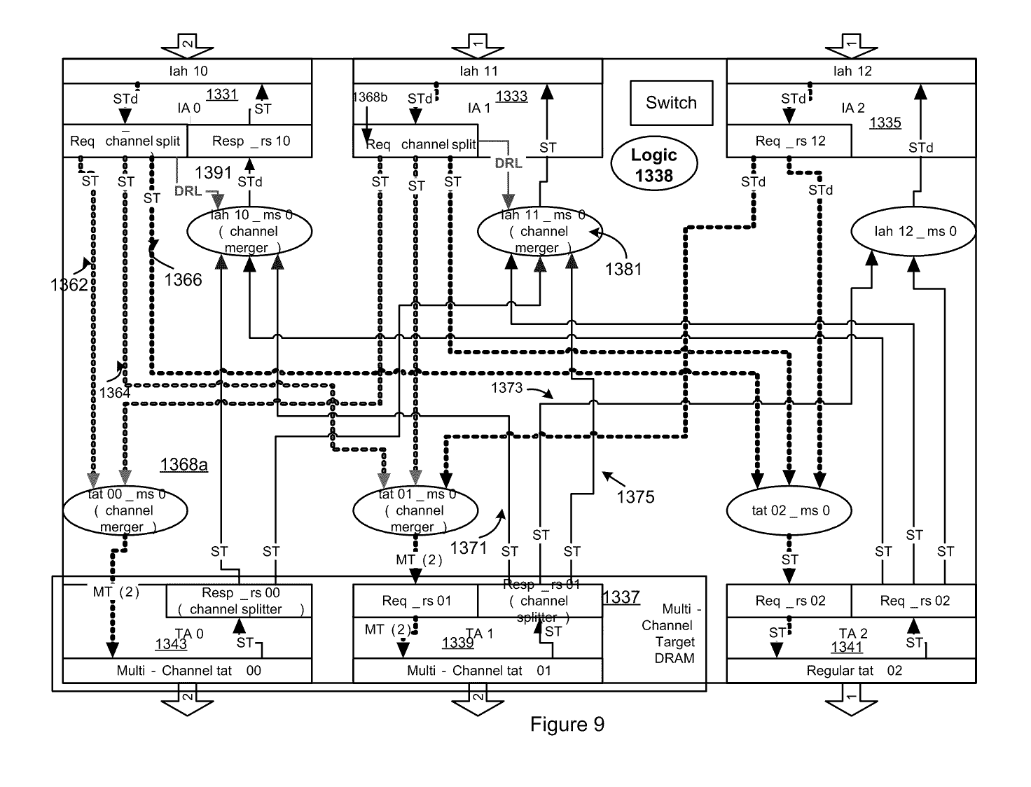

Referring to FIG. 9, transactions can be allocated (pushed/added to the cross over queue) in the request path 1362 and deallocated (popped/removed from the cross over queue) on the response path 1366. An example allocation operation is shown in pseudo-code below. Allocation only happens for request phases. A new transaction (part A of the pseudo code below) is “accepted” only if it can be allocated a buffer pool entry. Otherwise, this transaction and the following transactions for that thread are blocked.

1. With the crossover storage structure in place, the initiator agent request path tag logic can be loosely described by the following steps

a. When an OCP request is accepted, one of several things can happen depending on the configuration of the initiator agent:
i. If taginorder is enabled on the initiator agent OCP, and MTag InOrder is asserted for this transaction, the last CAM entry is always used in the CAM push/update operation.

ii. If condition (i) above is false, the “normal” CAM operation kicks in; the MTag id (itag id) value is used as the CAM search word. A CAM entry may or may not already exist for this itag id. If it exists (CAM hit), the existing structure is updated accordingly. If it doesn't exist (CAM miss), a new CAM entry is needed for this transaction. If the CAM is full, the request is blocked until an entry frees up. If a CAM entry is available, it is taken by this request; the itag id is stored in the CAM entry.

The pseudo code below shows an example algorithm to add and remove transaction entries into the crossover storage structure—comments in the pseudo code below are bracketed within “/* */” and help in understanding the pseudo code.

```
A. Allocation (for incoming new transaction) - applies only to
request phase
if buffer_pool has free entry /* implemn likely to maintain one-hot
vector */
        if CAM hit or CAM has free entry or MTagInOrder = 1
(in incoming transaction) then
          buffer_pool[trans_index]. transn ← transn_info
    buffer_pool[trans_index]. ptr ← NULL
    buffer_pool[trans_index]. free ← false
  if MTagInOrder = 1 in incoming transaction then
    interconn_tag id ← #tags_int + 1
    if CAM[interconn_tag id].first = NULL then /* means CAM
miss - first transaction with this tag id or first transaction with
MTagInOrder set */
      CAM[interconn_tag id].first ← trans_index
      CAM[interconn_tag id].last ← trans_index
      If MTagInorder <>1 in incoming transn then /*update search
field */
          CAM[interconn_tag id].initiator_id ← MTag id
        endif
    else /* 2nd or later transaction with MTagInOrder set or with
this initiator tag id*/
      buffer_pool[CAM[interconn_tag id].last].ptr ← trans_index
      CAM[interconn_tag id].last ← trans_index
    endif
  else block thread /* OCP multithreaded interface NOT necessarily
blocked */
  endif
else block thread /* OCP multithreaded interface NOT necessarily
blocked */
endif
```

B. Allocation (for incoming ongoing transaction)—applies to burst request phases
update buffer_pool[CAM[interconn_tag id].last].trans

The deallocation operation is shown in pseudo-code below.

Deallocation happens when the last internal interconnect response corresponding to that OCP transaction occurs via Logic detecting for the last response.

```
Deallocation (per incoming transaction)
if CAM[interconn_tag id].first = CAM[interconn_tag id].last /* this is
the only transaction for this tag id */
    buffer_pool[CAM[interconn_tag id].last].free ← true /* release
buffer pool entry */
    CAM[interconn_tag id].init_tag id ← NULL /* release CAM entry
note: may be instead implemented with extra free/occupied bit */
Else /* multiple transactions associated with this tag id */
    tempindex ← CAM[interconn_tag id].first
    CAM[interconn_tag id].first ← buffer_pool[tempindex].ptr
    buffer_pool[tempindex].free ← true
endif
```

### User Configurable Parameters

Each instance of the integrated circuit has a runtime user programmable parameter 449 that allows a creator of that instance of the integrated circuit to set the CAM-based crossover storage structure size dependent on a maximum number of outstanding transactions/per thread at any given time at the initiator agent (or target agent) containing the cross over queue structure. Each instance of the integrated circuit may have different sized crossover storage structures depending on the programmed in parameter 449 by the user. The maximum number of outstanding transactions limit is set by the user, and thus, the user sets the size of the crossover storage structure at the agent based on the number of outstanding transactions/per thread that the associated IP core generates. Also, each instance of the integrated circuit has a runtime user programmable parameter 449 that allows a creator of that instance of the integrated circuit to specify a maximum number of distinct interconnect tag id numbers per thread id that can be active at any instant for an agent containing the cross over queue structure, which then is used to generate an amount of possible entries of the CAM structure of the cross over queue structure. Note when the user specifies the total number of outstanding transactions per thread at that agent, that setting is used to generate the size of the buffer pool. Thus, each instance of the integrated circuit has a runtime user programmable parameter that allows a creator of that instance of the integrated circuit to specify a maximum number of outstanding transactions per thread that can be active on the interconnect from a given agent at any given point in time, across all of the tags on that thread, which then is used to generate a size of the buffer pool. The size of the CAM and the Buffer Pool in, for example, a target agent are based on the user specified parameters, #tags_tgt and #trans respectively at each target agent. Likewise, for the size of the CAM and the Buffer Pool in an initiator agent.

In addition to the OCP related tags parameters 449 that can be set, the following architectural parameters 449 can be set by the user. Some examples are:

1. #distinct (interconnection) tag ids (#tags_int): This is the number of distinct tag ids that can be active at any instant per thread at each initiator agent. Note that this is different from the number implied by the set of the OCP tags parameter. For example, let tags=8. This implies that the binary encoded *Tag id values can assume values from 000b to 111b. Assume, however, that the interface only generates odd numbered tag values: 1, 3, 5, and 7. The user can then set the #distinct tag ids to be for example 4, instead of the amount that is assumed by default. This parameter can be set on per thread basis at each initiator agent.

2. #distinct (target) tag ids (#tags_tgt): This is the number of distinct tag ids that can be active at any instant per thread at each target agent (i.e., those launched into the target core (TC)). Note that this is different from the number implied by the set of the OCP tags parameter at each target agent.

3. #outstanding transactions (#trans): this is the total number of outstanding transactions per thread. This parameter can be set on per thread basis at each initiator agent and at each target agent.

4. Tag Id Type at target: At each target agent, the user can specify one of three types of tag ids: Compact, Partially Compact, Pass-Through. With partially compact tag type, the user can specify the contiguous set of bits that need to be part of the MSbits of the target agent tag id.

The initiator and target agent command Interconnect_tags' that allows the user to specify the number of distinct interconnect tag ids per thread id that can be active at any instant for that agent. This number must be >=1 and <=tags as specified on the agent OCP interface. This value can be set either uniformly for all threads or on a per-thread basis for that agent. The max_trans command is used to specify the total number of outstanding transactions per thread at that agent.

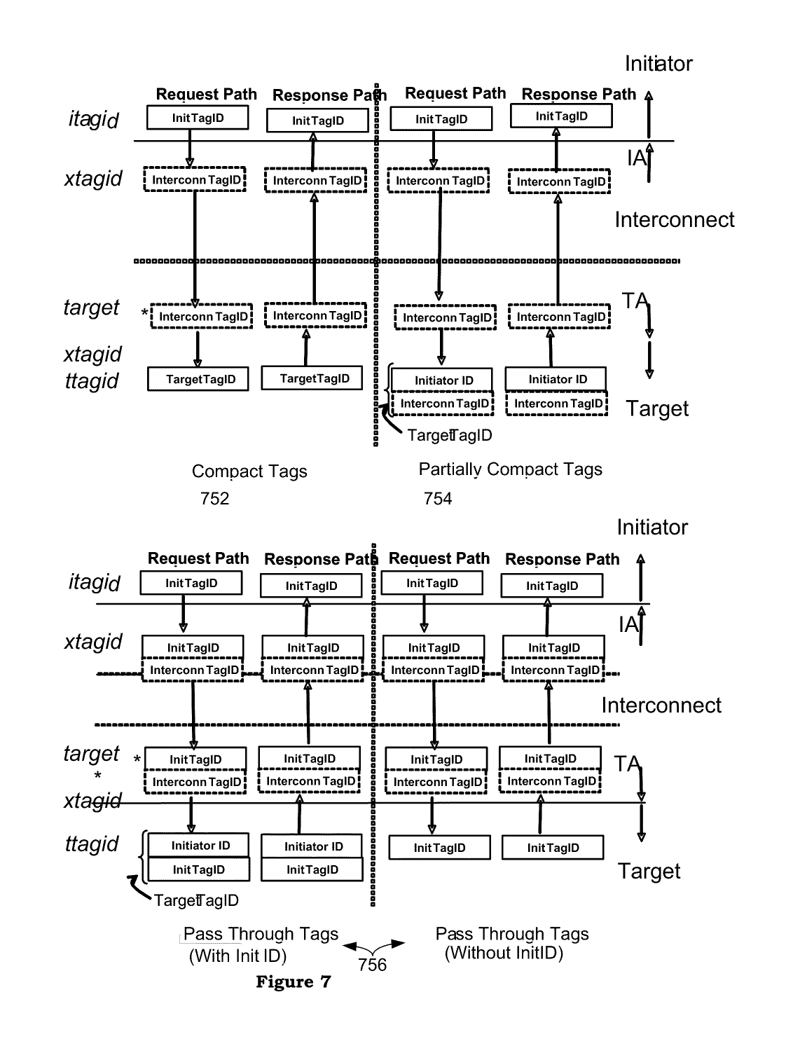

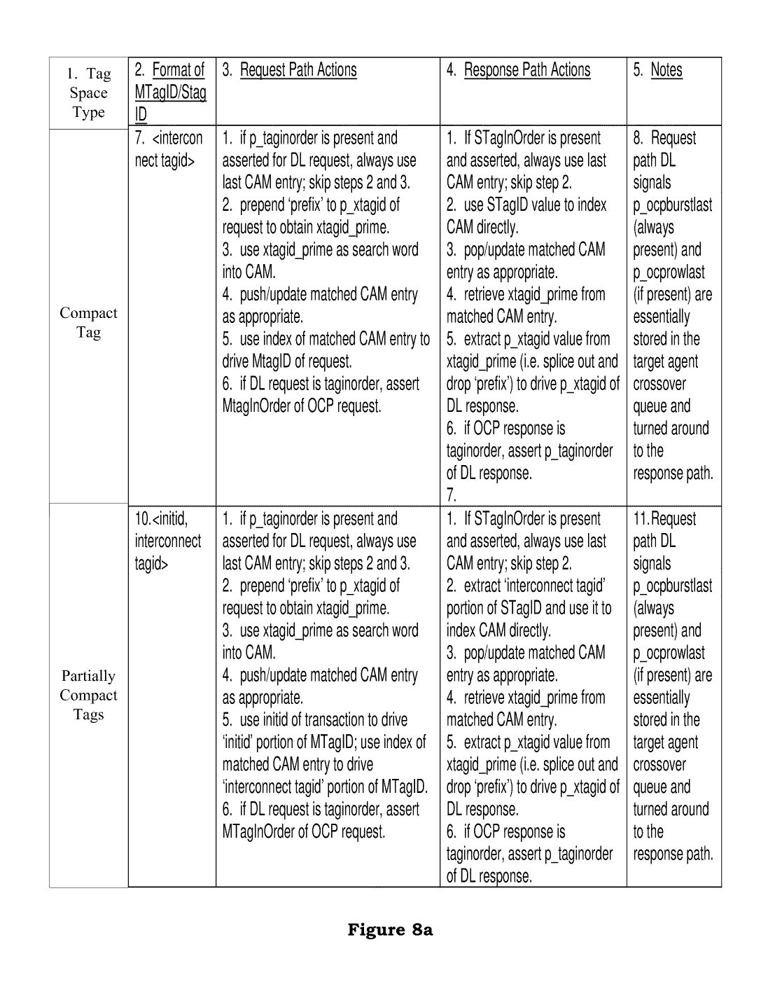

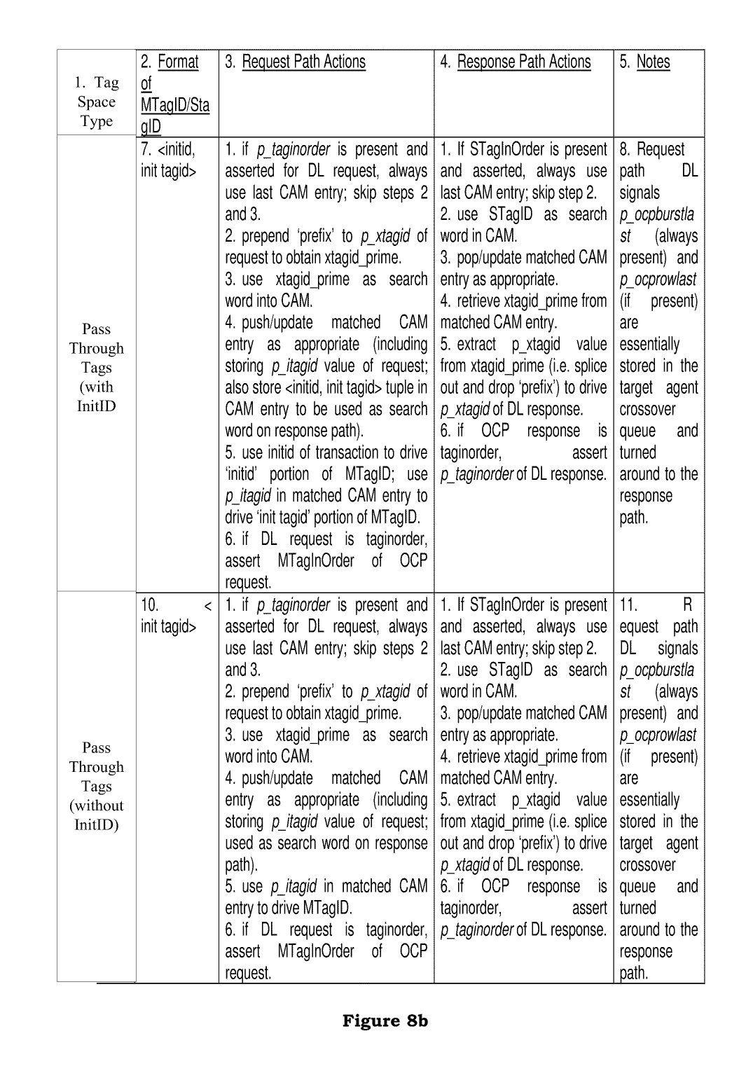

FIG. 7 illustrates the tag logic that is configured to support different types of tags, including Compact Tags, Partially Compact Tags, Pass Through Tags with Init ID, and Pass Through Tags without Init ID to alter an allocation and a de-allocation operation of assigning internal interconnect tag id number to a thread from the crossover storage structure. FIGS. 8a and 8b illustrate agent Request and Response Path Logic for each Tag Space Type.

The system distinguishes types of tagged systems depending on how the tag ids are generated. Depending on the type of tag that is generated, the CAM structure and the allocation/deallocation operations vary as described below:

1. Compact Tags 752: The target tag id (ttag id) is generated by the interconnect. At each TAT, the incoming xtag id is mapped to a ttag id. The mapping depends on the user specified number of tags at the target agent for this thread. The ttag ids are numbered from 0 and are compactly represented. Clearly, there is a 1:1 mapping if #ttag ids >=#xtag ids (for that thread); otherwise, there is a many-to-one mapping from xtag ids to ttag ids with a corresponding potential loss of concurrency.

Compact Tags 752: The OCP tag id that is generated is the index of the CAM structure at which this transaction is allocated at the target agent. The allocation and deallocation procedures are similar to those at the initiator agent. The CAM search field is the incoming interconnect tag id and is used for allocation. The compact tag id field in the returning OCP transaction is the index which is used for deallocation. Since the deallocation is based on an index, the operation is expected to be fast.

2. Partially Compact Tags 754: This scheme of target tag generation fits in between the notions of “compact” and “pass through” tags. The ttag id is generated as a concatenation of <initiator id, xtag id>. The initiator id is unique across all initiators and is usually assigned by the system integrator or by the interconnect (the latter is the default). It is the user's responsibility to assign enough number of bits for the target tag id to accommodate this definition.

Partially Compact Tags 754: The OCP tag id that is generated is the 2-tuple <initiator id, interconnect tag id>. The interconnect tag id, i.e. interconnect tag id is used as the search field for the response OCP transaction (and for the incoming DL transaction also). Essentially, the initiator id is ignored as far as decoding the OCP response is concerned

3. Pass Through Tags 756: This tag scheme is characterized by the fact that initiator tag id information is passed through the interconnect to that target core. Pass Through Tags 756: The OCP tag id that is generated is either the 2-tuple <initiator id, initiator tag id> or just <initiator tag id> depending on the flavor of Pass Through Tags being used (Pass Through Tags With Initl D or Pass Through Tags Without InitID, respectively). In either case, the tag id is stored in the CAM and is used as the search field for the response OCP transaction. This tag id could also be used as the search field for incoming DL transactions but there are advantages to using the interconnect tag id field: a) this path will be similar to the “compact tags” variant, b) the interconnect tag id search field width is likely to be much smaller than this tag id—hence, there are some wiring and timing advantages.

There are two flavors of Pass Through Tags 756:

1. Pass Through Tags (With InitID): The ttag id is generated as the concatenation of <initiator id, itag id>. The initiator id is unique across all initiators and is usually assigned by the system integrator or by the interconnect (the latter is the default). Itag id is the initiator tag id of the transaction as it appeared on the initiator OCP. It is the user's responsibility to assign enough number of bits for the target tag id to accommodate this definition. Pass through tags permit the user to essentially map the initiator tag ids to the target tag ids. The tag ids are expected to be sparsely populated. When using Pass Through Tags With Initl D, there is a 1:1 mapping between the interconnect tag id and the <initiator id, initiator tag id> fields. Therefore it is OK to use both these fields for search in the CAM. The exception to this arises when initiator id is identified only by the initiator port# and two threads belonging to the same initiator agent are mapped (merged) to the same target agent thread—in such a case, the interconnect tag ids from the two threads are distinct but the 2-tuples could be identical. For this exception case, which can be statically inferred (2 threads from same initiator mapped to same target thread and initiator id does not carry thread id info), the search field has to be the 2-tuple for both incoming DL transaction and the OCP response transaction at the target agent.

2. Pass Through Tags (Without Initl D): The ttag id is generated solely as <itag id>, where itag id is the initiator tag id of the transaction as it appeared on the initiator OCP. It is the user's responsibility to assign enough number of bits for the target tag id to accommodate this definition. The tag ids are expected to be sparsely populated.

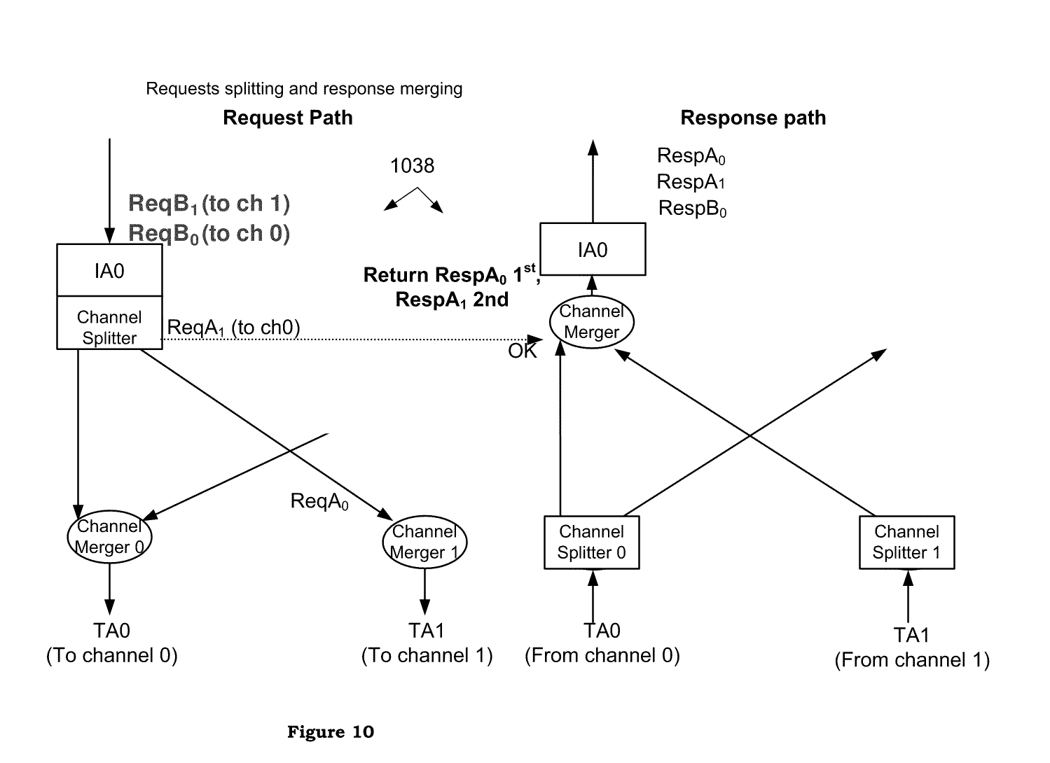

FIGS. 9 and 10 illustrate the tag logic in the interconnect which allows tag assigning to be implemented in a multiple channel aggregate target IP core environment. Interleaved channels make up the multiple channel aggregate target IP core 1337.

Many kinds of IP core target blocks can be combined and have their address space interleaved. The below discussion will use discreet memory blocks as the target blocks being interleaved to create a single aggregate target in the system address space. An example “aggregate target” described below is a collection of individual memory channels, such as distinct external DRAM chips, that share one or more address regions that support interleaved addressing across the aggregate target set. Another aggregate target is a collection of distinct IP blocks that are being recognized and treated as a single target by the system.

Distinct memory IP cores can be divided up in defined memory interleave segments and then interleaved with memory interleave segments from other memory IP cores. Two or more discrete memories modules, including on chip IP cores and off chip memory cores, may be interleaved with each other to appear to system software and other IP cores as a single memory (i.e., an aggregate target) in the system address space. Each memory module may be an on-chip IP memory core, an off-chip IP memory core, a standalone memory bank, or similar memory structure. The interconnect implements the address map with assigned address for the plurality of target IP cores in this integrated circuit, including a first aggregate target with two or more memory channels that appear as a single target to the initiator IP cores. Two or more memory channels that make up the first aggregate target of the target IP cores populate an address space assigned to the first aggregate target and appear as a single target to the initiator IP cores. The memory controller may be configured to regulate data flow between the initiator IP cores and the first aggregate target.

The interconnect include three initiator agents 1331, 1333, and 1335 and three target agents, where target agent0 1341 and target agent1 1339 are target agents that belong to a multi-channel target, DRAM. Only one multi-channel aggregate target 1331 exists in this example.

On the request network, for initiator agent 1331, the multi-channel path going to the multi-channel target DRAM splits at the initiator agent0's 1331 embedded, request-side thread splitter units, Req_rs10. Since there are two channels, the two outgoing single-threaded (ST) links 1362, 1364 each goes to a different channel target. The third outgoing ST link 1366 is a normal path leading to a normal individual target agent TA2 1341. However, the important point is that the multi-channel request from the initiator is split at request-side thread splitter units, Req_rs10, and then sent to different physical targets, target agent0 1343 and target agent1 1349. A request-side channel splitter can be embedded in the initiator agent 1331. For the channel target agent0 1343, the merger splitter unit component, tat00_ms0 1368a, and target agent0 1343 act as a channel merger unit and regulate channel traffic coming from two different initiator agents, such as initiator agent0 1331 and initiator agent1 1333.

On the response network, for target agent1 1339, the embedded component, Resp_rs01, acts as a response channel splitter—it has three outgoing links 1371, 1373, 1375 for delivering channel responses back to initiator agent0 1331, normal responses back to the normal initiator agent2 1333, and channel responses back to initiator agent1 1335, respectively. This merger-splitter logic unit uses information from the request path to selectively backpressure incoming branches and threads to effectively reorder the multi-channel responses from different channel targets and achieve the correct response order. For initiator agent1 1333, its upstream merger splitter unit component, lah11_ms0, is a channel merger, which not only regulates responses coming back from channel 0 (i.e., target agent0) and channel 1 (i.e., target agent1) in the aggregate target 1337, but also handles responses returned by the normal target agent2 1341. The response-side channel merger 1381 receives responses from target agent0 1343, target agent1 1339, and target agent2 1341.

Since a response-side channel merger unit needs to regulate channel responses but it may not have enough information to act upon, additional re-ordering information can be passed to the merger unit from the request-side channel splitter of the initiator agent. For instance, the link 1391 is used to pass response re-ordering information between the request-side channel thread splitter unit, Req_rs11, and the response-side channel thread merger unit, lah11_ms0, for initiator agent1 1333.

Target agent TA0 1343 is assigned to channel 0 and target agent TA1 1339 is assigned to channel 1 for the multi-channel target DRAM. Connectivity between initiators and individual targets of the multi-channel target DRAM is done via connectivity statements that specify the initiator agent (connected to an initiator) and the specific target agent (connected to an individual target of the multi-channel target DRAM) as shown in the example.

The interconnect tag logic 1138 is configured to permit multiple outstanding transactions to the same multi-channel aggregate target IP core on different assigned internal interconnect tag numbers from a given thread. The logic in the initiator agent applies the specified conditional behavior only when the initiator agents and target agents in question have multiple tags configured on their OCP interfaces and the TAs are part of a multi-channel group. The tag logic 1138 differentiates between channel-splitting requests verses non-channel-splitting requests of a transaction headed to the multi-channel aggregate target IP core. Otherwise, the interconnect behavior defaults back. Any transaction traffic consisting of both non-channel-splitting and channel-splitting requests will still be supported in terms of correctness returning the responses of a transaction back to the initiator IP core in the expected execution order via the interconnect tag logic 1138 within the interconnect. Thus, the tag logic 1138 has a detector to detect whether a request of a transaction from a given thread spans over at least a first and second memory channel in a multiple channel aggregate memory target IP core and applying interlocks, so that in terms of correctness, all of the responses of the transaction are routed back across the interconnect to the initiator IP core in the expected execution order via tag logic 1138 within the interconnect. The tag logic 1138 at least enforces a restriction of one open logical target per tag per thread to support a multi-channel target agent or a multi-channel target group.

The tag logic 1138 in the interconnect to assist may include interlock logic, a target agent mode switch, logic in a memory controller, and other logic.

The interlock logic within the interconnect supports multiple outstanding multi-channel requests to the same multi-channel aggregate target on different tags in a given thread. A problem occurs at the response merger-splitter logic unit that can control the order in which response to the multi-channel requests are sent back to the initiator agent. The interlock logic of the tag logic 1138 is configured to permit multiple outstanding transactions to the same multi-channel aggregate target IP core and eliminate an introduction of an out-of-order return of tagged responses within a given thread from a multiple channel aggregate target.

Each instance of the integrated circuit has a runtime user programmable parameter that allows a creator of that instance of the integrated circuit to specify a setting of a mode switch that specifies the tag logic's mode of operation on a per-agent-thread basis. (For example, see FIG. 3 mode switch 679) The mode of operation is selectable based on the type of initiator IP cores in that instance and the type of target IP cores in that instance. The target agent mode switch (imt_tags_mode) is added to allow users to specify the IMT/Tags mode of operation on a per-target-agent-thread basis. The following three example modes will be available: initiator agent Request Interlocking (ia_interlock_req) (default mode for the switch); target agent serializes Requests to a Single Tag (ta_single_tag_req); and Target Returns Responses in Request Order on a Thread (ta_in_order_resp). Thus, each instance the integrated circuit has a runtime user programmable parameter that allows a creator of that instance of the integrated circuit to specify a setting of a mode switch that specifies the tag logic's mode of operation on a per-agent-thread basis, wherein mode of operation is selectable based on the type of initiators IP cores in that instance and the type of target IP cores in that instance.

Each of these modes serve to prevent the one problem that causes the IMT/Tags response reordering issue: tagged responses (in a given thread) at a multi-channel target agent being reordered by the target core. The logic ensures that no tagged response reordering can ever occur at a multi-channel target agent.

These three example modes are described in detail below.

Mode 1—initiator Agent Request Interlocking Logic (“ia interlock req” mode)

The tag logic 1138 is configured to permit multiple outstanding transactions to the same multi-channel aggregate target IP core on different initiator agent tag numbers from a given thread. The tag logic 1138 differentiates between channel-splitting request verses non-channel-splitting requests of a transaction headed to the multi-channel aggregate target IP core. The tag logic 1138 is configured to 1) enforce a restriction of a single open logical target rule per same initiator agent tag per thread for non-channel-splitting requests being routed to the multi-channel target IP core, 2) permit multiple non-channel-splitting requests on different initiator agent tags in a given thread to be outstanding because the crossover storage structure can handle out-of-order return of responses among tags, 3) permit at most one outstanding channel-splitting request per thread. Of course, channel-splitting requests, on the other hand, by definition go to multiple physical targets making up the multiple channel aggregate target IP core at the same time.

For initiator agent threads connected to target agent threads using this mode, The initiator agent/RS/MS will enforce the following rules:

Interlock #1: The initiator agent will enforce a single open (physical) target rule per tag per thread for non-channel-splitting requests to multi-channel target groups. The initiator agent will not launch a new transaction into the interconnect fabric if this rule is violated (similar to today's open target rule per thread).

Channel-splitting RS units (request path) will only perform DRL operations for channel-splitting requests.

Channel-merging MS units (response path) will only perform “controlled backpressure” operations for channel-splitting responses. No RS/MS changes are necessary here. Single open (physical) target rule per tag per thread rule for non-channel-splitting requests to multi-channel target groups

Restriction 1a above (Interlock #1) now prevents the initiator agent from sending two such non-channel-splitting requests (on a given tag and thread) out at the same time. Therefore, the “controlled backpressure” mechanism is no longer needed for non-channel-splitting requests (hence modifications 1b and 1c above). Note that multiple non-channel-splitting requests on different initiator agent tags (in a given thread) can still be outstanding because the initiator agent crossover storage structure can handle out-of-order return of responses among tags.

Interlock #2: The initiator agent will allow at most one outstanding channel-splitting request per thread. The initiator agent will not launch a new transaction into the interconnect fabric if this rule is violated. Channel-splitting requests, on the other hand, by definition go to multiple physical targets at the same time. The “controlled backpressure” mechanism is still required for these transactions. However, to prevent the IMT/Tags issue, restriction 1d above (Interlock #2) only allows one outstanding channel-splitting request per thread (this includes all tags in the thread).

The interlock logic in the initiator agent does not send out a multi-channel request on a given tag if there is already an outstanding multi-channel request on a different tag in that same thread that also targets the same multi-channel aggregate target. All responses for the outstanding multi-channel request must return before the blocked 2^{nd} multi-channel request is allowed to be sent to the same aggregate target. Restriction: The logic in the initiator agent cannot send out a multi-channel request on a given tag if there is already an outstanding multi-channel request on a different tag in the same thread that targets the same multi-channel group.

Interlock #3: The initiator agent will not allow a non-channel-splitting transaction and a channel-splitting transaction to both be outstanding on a thread. With respect to traffic that consists of both non-channel-splitting and channel-splitting transactions, restriction 1e above (Interlock #3) takes the conservative approach. In a given thread, the initiator agent will not dispatch a non-channel-splitting request to the fabric if a channel-splitting request is already outstanding, and vice versa. This behavior could result in significant performance loss if the traffic on a thread consists of many non-channel-splitting and channel-splitting transactions in close proximity to each other.

### Mode 2

Target agent serializes Requests to a Single Tag mode (“ta single tag req” mode).

This mode instructs the target agent to use the same outgoing MTag id value for all outstanding requests from a given initiator source (i.e., initiator agent and thread) on this target thread, even though the target is tagged. Characteristics of this mode include the following:

A small amount of additional target agent tag logic is required to implement this behavior. Internally on the request path, the target agent tag logic forces all incoming interconnect requests from a given initID (on the given target thread) to use the same crossover storage structure entry, thus forcing the subsequent OCP requests to have the same outgoing MTag id value.

Threads on which this feature is enabled effectively degenerate to a 1-tag thread for any given initID; therefore no response reordering can occur on that thread for any given initID.

Note that Pass Through Tags tag space (with or without InitID) is not supported in this mode. Only Compact Tags and Partially Compact Tags tag spaces are supported.

### Mode 3

Target Returns Responses in Request Order on a Thread (“ta in order resp” Mode)

This mode indicates whether tagged responses from the target core are guaranteed to return in the order of their requests. When enabled, the target core must obey this rule. Runtime assertions will be added to enforce this behavior at the target agent.

The memory scheduler is forced to keep track of the order of responses. Multi-channel target agents can connect to the memory scheduler instances. The memory scheduler returns tagged responses in order of their requests that are expected to be executed by their corresponding initiator IP core. The memory scheduler implements either the CAM and Buffer Pool crossover storage structure or response reorder buffers to ensure tagged responses are returned in order of their requests. The memory scheduler supports requests on multiple tags tagged concurrency. The memory scheduler can optimize tagged requests for memory access.

The memory scheduler can be modified to support this mode with the following example changes: a per-thread switch (enable_inorder_only_responses) is added to the memory scheduler instance to indicate whether it is forced to return tagged responses in order of their requests on any given thread. This change has the following characteristics:

Implementation of this feature in the memory scheduler requires the addition of per-thread response reorder buffers whose depth is user-configurable. configurable. The existing response buffer structure inside the memory scheduler is OK, and the control logic is specialized. From a user's standpoint, the memory scheduler needs/wants larger response buffers to support larger amounts of request reordering when this feature is enabled.

From a user's perspective, if multi-channel TAs are connected to the memory scheduler instances, those TAs can set their imt_tags_mode values to “ta_in_order_resp” on some or all threads and the memory scheduler instances can set their enable_inorder_only_responses values to 1 on the corresponding threads. The result is that these memory scheduler instances will always return tagged responses in order of their requests, thus avoiding the out of order tags problem.

The general idea is that a tagged memory scheduler will still be able to take advantage of tags to re-order requests issued to the DRAM controller to optimize DRAM efficiency. However, the change allows the memory scheduler to re-order DRAM controller responses to preserve the OCP response ordering needed by IMT DRL.

Given a design that contains multiple target agents with tags >1 in a multi-channel aggregate target, the switches imt_tags_mode “ia_interlock_req” setting will be used by default for all target threads. Depending on the type of traffic being routed to each target thread, and depending on the characteristics of the target cores (or memory scheduler instances) connected to the target agents, users can change the imt_tags_mode settings for select threads to “ta_single_tag_req” or “ta_in_order_resp” to improve overall system performance. The following section discusses the performance repercussions associated with the setting of imt_tags_mode.

### Multiple Multi-Channel Requests on Different Tags in a Thread

Without multiple channel tag logic, the introduction of tags within a thread could break an interconnect because of the lack of per-tag flow control in the DL and OCP protocols, which underline the major difference between threads and tags. Without this level of flow control, multiple channel response reassembly cannot be achieved on a per-tag level by using the current back pressuring methodology.

Referring to FIG. 10, consider two back-to-back multi-channel requests sent from IA0. Both requests have the same thread id but different tag ids. The first request gets split (at Req_rs10) into two parts, A0 and A1, which get sent to TA0 and TA1, respectively. Then the second request gets split (also at Req_rs10) into two parts, B0 and B1, which get sent to TA0 and TA1, respectively. If the slave connected to TA0 returns the response for B0 before the response for A0 (which is now possible because the requests are on different tags), response B0 will reach the channel merger (lah10_ms0) first and be let through. The channel merger will then block branch 0 and unblock branch 2. If the slave connected to TA1 happens to return the response for A1 before the response for B1, then A1 will reach the channel merger lah10_ms0 first and be let through (on branch 2). This breaks the system because IA0 will have received the response for A1 before it received the response for A0.

The tag logic 1038 using the interlock logic above eliminates an introduction of an out-of-order return of tagged responses within a given thread from the multiple channel aggregate target IP core.

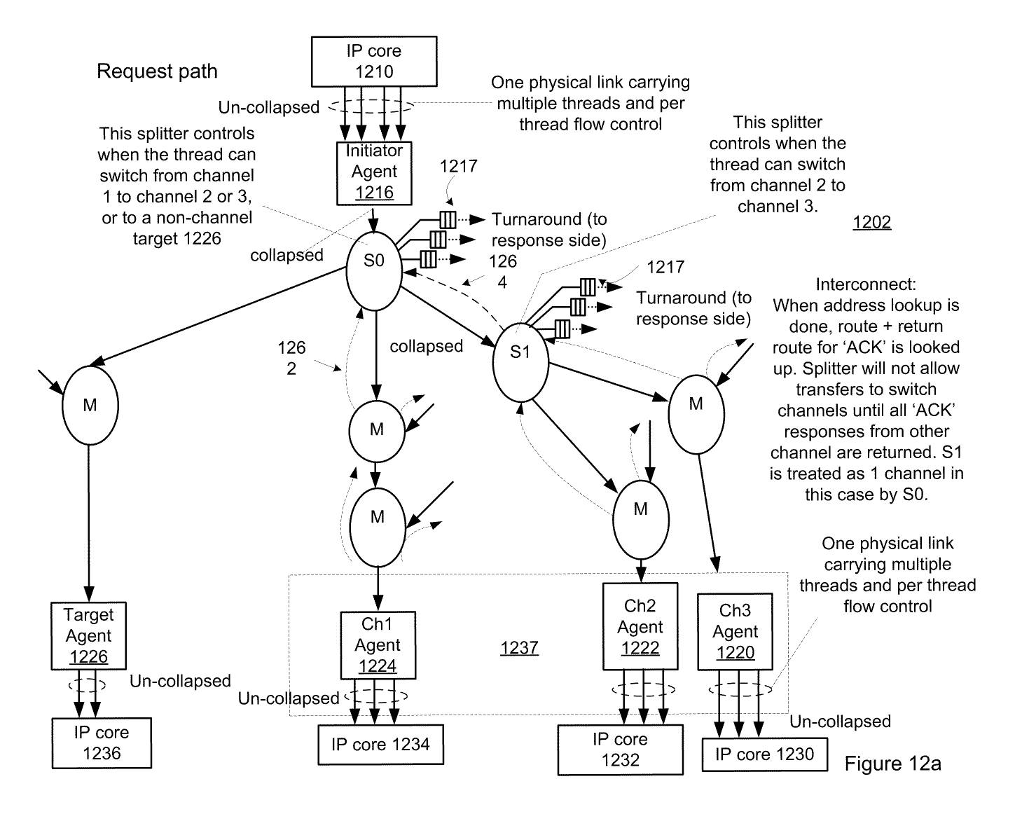

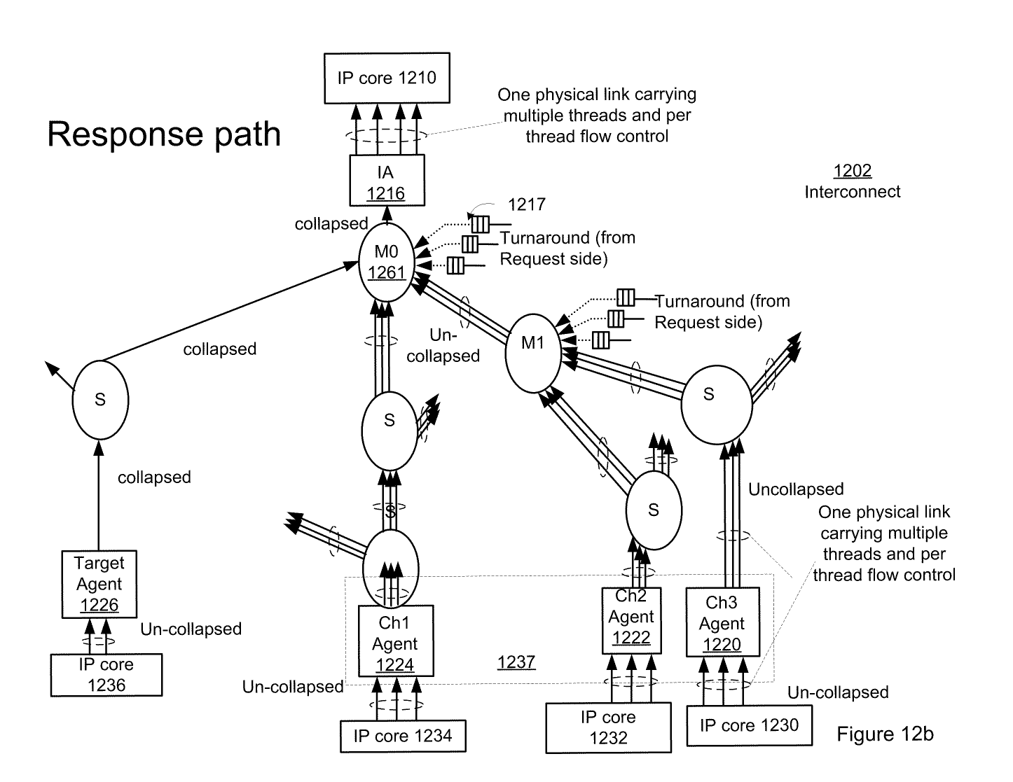

FIGS. 12a and 12b illustrate thread collapsing logic within the interconnect in a system having one or more multiple channel target IP cores (e.g., multiple channel target 1237 has 3 channels). Thread collapsing logic exists in an initiator agent 1216 configured to collapse multiple IP core User thread IDs from the IP core 1210 into a single collective interconnect thread ID from the initiator agent 1216 to eliminate some of the FIFO buffer/memory area occupied and other logic area occupied on the chip by the interconnect 1202 itself. Thus, multiple independent threads, each with a different thread ID, from the same IP core (initiator or target IP core) may be condensed/collapsed into a single collective interconnect thread ID when traveling over the request side of the interconnect 1202 from initiator IP core 1216 to the multiple channel target 1237 (FIG. 12a). Also, merely, on the response side of interconnect 1202 (FIG. 12b), between the multiple channel target 1237 to the last channel merger unit 1261 and the initiator agent 1216 itself are having multiple independent threads, each with a different thread ID. For the rest of the response side of interconnect 1202, threads of initiator or target IP core are collapsed into a single collective interconnect thread ID when traveling. The target IP cores supporting collapsing the transactions of multiple threads into a common/single aggregate interconnect thread may be a multiple channel target 1237 or a regular target 1226 and target IP core 1234. The single collapsed interconnect thread collectively containing the transactions from the multiple independent IP core User thread is governed by single threaded flow control logic at each merger unit and splitter unit within the interconnect 1202 and carries transactions belonging to more than one IP core User thread ID. The single collective interconnect thread ID while traveling through the interconnect 1202 share a common storage structure at each request splitter or request merger unit. The FIGS. 12a and 12b show an initiator IP core 1216 multithreaded with, for example, four threads which are collapsed on the request side to a single aggregate interconnect thread ID. Among these four collapsed threads, two of them can go to the regular target IP core 1236, and three of them can go to the multiple channel target 1237 and then to target IP cores 1230, 1232, and 1234. For those two threads going to the regular target IP core 1236, they are sent back on the response side as one interconnect thread ID. And, for those three threads going to the multiple channel target 1236, they are sent back on the response side as four separate interconnect thread IDs up until the last merger unit 1261 closest to the initiator agent 1216.

Mapping logic in the agent 1216 is configured to dynamic map each IP core thread ID to the single interconnect core thread ID. If multiple independent threads from the same IP core are collapsed into a single output thread, the thread collapsing logic inserts an additional field in the collapsed thread's route header information, such as its source routing information, for the interconnect core thread ID, which indicates which independent uncollapsed IP core thread ID each transaction in the interconnect thread ID belongs to.

As discussed on the request side of the interconnect 1202, the single collapsed interconnect thread is used to deliver the transactions from the multiple independent IP core User thread to their respective target IP cores 1230, 1232, 1234, 1236. On response side of the interconnect back from a multiple channel target IP, using un-collapsed interconnect thread IDs and per thread flow control logic in the merger and splitter units eliminates any need for a re-order buffer at the multi-channel target or at the initiator agent 1216. In addition, due to the un-collapsed interconnect thread IDs and per thread flow control logic being configured to control the return order of the transactions within these interconnect threads, deadlock situation is eliminated. The flow control logic controls when the order in which thread IDs can be serviced and returned in order to properly and efficiently handle multichannel interleave boundary crossing when multiple initiator threads are collapsed on the request network side and/or multichannel response re-assembling when multiple initiator threads are collapsed on the response network. The multiple channel target IP cores 1230, 1232, and 1234, each has a FIFO buffer and logic for each of the multiple IP core User thread IDs. This allows the single collective interconnect thread ID to be uncollapsed back into effectively the original IP core user thread IDs. On the response side, the flow control logic is set per thread ID avoid a deadlock situation in response order coming back from the multi-channel target.

On the request side, at each merger and splitter unit, the acknowledge logic maps the single acknowledge signal 1262 or 1264 from a downstream merger or splitter unit to the appropriate IP core thread ID in the single interconnect thread ID.

As discussed, a single share storage structure exist at each request splitter or request merger unit per interconnect thread ID, but the number of turnaround queues, such as turnaround queues 1217, that exists at each request splitter unit is equal the number of IP core User thread IDs.

In an embodiment, a thread collapsed interconnect link has single threaded flow control but carries transactions belonging to more than one IP core User thread ID. At any point in the interconnect 1202 where collapsed threads on the same link take different paths leading toward any downstream multiple channel target, the information is extracted from the route information in that thread. In the interconnect fabric, the extraction can be performed by the initiator agent (response path), target agent (request path) or splitter unit (request path). In this case, the information is placed in an additional field in the routing portion of the thread. The splitter unit uses the source routing information to steer the transactions. In the case of request thread collapsed target agent or response thread collapsed initiator agent, the unit extracts the threadid from the route directly, without making use of the additional field in the routing portion of the thread.

Dynamic thread mapping occurs at splitter units. The collapsed interconnect links carrying more than one thread but have single threaded flow control. At some point in the request path, collapsed initiator threads must be mapped to target threads. At some point in the response path, collapsed target threads must be mapped to initiator threads. The dynamic mapping logic accomplishes both of these task. In these cases, the initiator agent (response path), or target agent (request path) or splitter unit (request path) will extract a thread ID from the route field. The splitter unit then uses this user thread ID information to dynamically control the turnaround queue associated with the user thread ID.

The route is used in interconnect 1202 to steer transactions through the interconnect fabric from source to destination. This steering includes the process of thread mapping. The initiator agent has a table of routes to all target threads that it can talk to in the request path. The target agent has a table of routes to route transactions back to all initiator agent threads that can talk to that target agent.

In the request path, thread mapping maps initiator threads to target threads. In the response path, thread mapping maps target threads to initiator threads. Splitters and/or mergers unit have logic to handle thread renaming, thread merging and dynamic thread mapping. The necessary information to do this is configured structurally into the logic of the merger unit.

The routing mechanism is configured to handle user request thread ID collapsed initiators that have transactions serviced by a multi-channel target IP core 1237. Such a transaction carries its user thread ID information in the route information. A splitter unit that performs channel splitting needs to push an entry with re-assembly information into a turnaround queue that corresponds to the user thread ID that is carrying the transaction. The turnaround queue on the request side sends this re-assembly information over to the response network so the flow control logic in the response network may keep track of and let the responses from the target IP cores comes back in the expected execution order. The logic in the splitter units look for the additional information in the aggregate interconnect threads and use the information to place the transaction of the aggregate interconnect thread into each respective turnaround queue. Each turnaround queue is specific to a user IP core thread ID but the FIFO storage structure for the interconnect thread is shared by all the transactions in the aggregate interconnect thread.

On the Response Path of interconnect 1202, the link derivation program sets up all response links, which return from a multiple channel target to a thread-collapsed initiator up to the last channel merger, to have a number of interconnect threads equal to the number of user IP core threads of the initiator—rather than a single aggregate interconnect thread ID. In addition, the link derivation program also sets up the routing information so that transactions of target threads sent from target IP cores not only carry the routing information but also perform dynamic thread mapping or thread renaming along the response path to get back to their corresponding initiator threads before reaching any channel merger units. At the merger units 1261 and 1262 prior to the initiator agent 1216, that merger units 1261 and 1262 perform re-assembly of responses from the number of interconnect threads equal to the number of user IP core threads—these responses are sent across the interconnect 1202 from the multiple channel target IP core 1237.

The splitter unit can have turnaround queues that are connected to response path merger unite (via a turnaround queue link). There can be one turnaround queue for each splitter unit thread if the thread is not collapsed. If the input link is thread collapsed, there can be one or more turnaround queues. The input link is thread collapsed but it actually carrying traffic for multiple user thread IDs and logic of splitter refers to the additional field in the routing information carried by any channel transaction in order to insert proper re-assembly information to the correct turnaround queue among one or more turnaround queues of a channel splitter. To enable the multi-channel response are re-assembling properly, the re-assembly information must be passed from a request network channel splitter unit to its corresponding response network channel merger, a merger unit component. The turnaround queue link signals and parameters that are used by the interconnect 1202 internally relay this ordering information between a channel splitter unit and a channel merger unit.

The multiple channel target IP cores 1230, 1232, and 1234 do not support response thread collapsing and instead send out a number of interconnect threads equal to the number of initiator IP core user thread back across the interconnect 1202. On the request side of the interconnect 1202, the request path ordering (acknowledgement) mechanism ensures that deadlocks conditions are not created, even when request thread collapsing is enabled.

In the interconnect response network an initiator agent, which talks to a multi-channel target group and is response thread collapsed, needs to have non-collapsed multi-threaded response links, up to the last output link of the last channel merger unit that performs re-assembly of multichannel traffic. On the response network, if the next link downstream (towards the initiator agent 1216) of the last re-assembly channel merger unit is an splitter unit, the splitter unit will have single threaded buffering and flow control at the output side, but will have multi-threaded flow control at the input side.

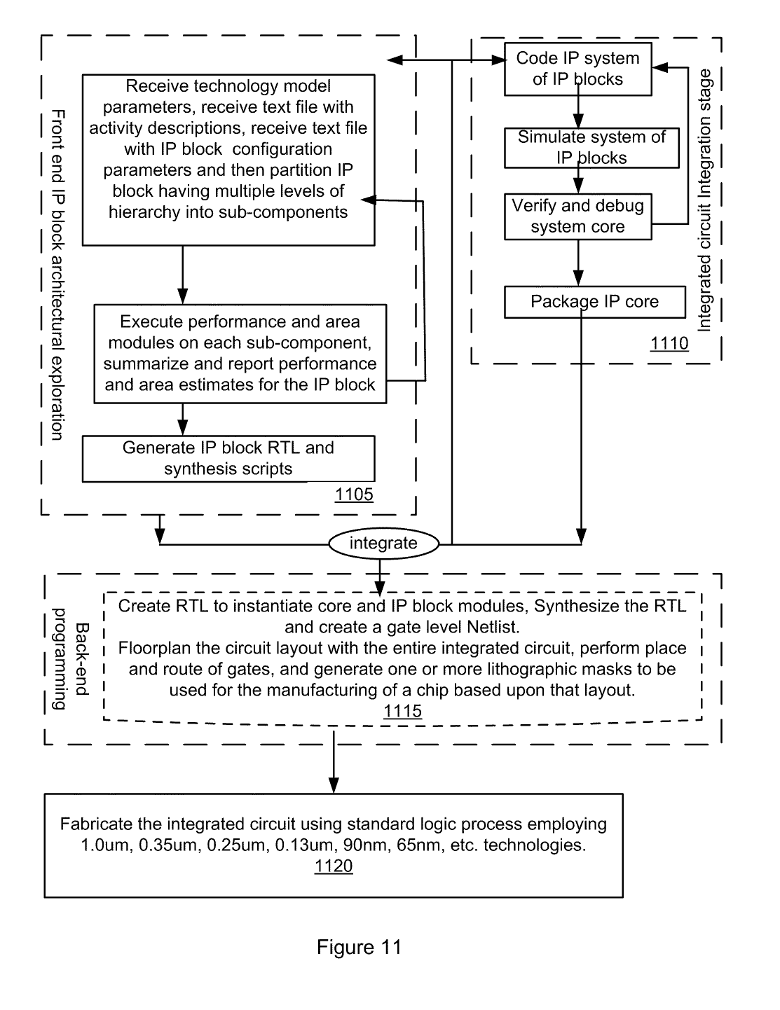

FIG. 11 illustrates a flow diagram of an embodiment of an example of a process for generating a device, such as a System on a Chip, with the designs and concepts discussed above for the Interconnect and Memory Scheduler. The example process for generating a device with designs of the Interconnect and Memory Scheduler may utilize an electronic circuit design generator, such as a System on a Chip compiler, to form part of an Electronic Design Automation (EDA) toolset. Hardware logic, coded software, and a combination of both may be used to implement the following design process steps using an embodiment of the EDA toolset. The EDA toolset such may be a single tool or a compilation of two or more discrete tools. The information representing the apparatuses and/or methods for the circuitry in the Interconnect Memory Scheduler, etc. may be contained in an Instance such as in a cell library, soft instructions in an electronic circuit design generator, or similar machine-readable storage medium storing this information. The information representing the apparatuses and/or methods stored on the machine-readable storage medium may be used in the process of creating the apparatuses, or model representations of the apparatuses such as simulations and lithographic masks, and/or methods described herein.

Aspects of the above design may be part of a software library containing a set of designs for components making up the scheduler and Interconnect and associated parts. The library cells are developed in accordance with industry standards. The library of files containing design elements may be a stand-alone program by itself as well as part of the EDA toolset.

The EDA toolset may be used for making a highly configurable, scalable System-On-a-Chip (SOC) inter block communication system that integrally manages input and output data, control, debug and test flows, as well as other functions. In an embodiment, an example EDA toolset may comprise the following: a graphic user interface; a common set of processing elements; and a library of files containing design elements such as circuits, control logic, and cell arrays that define the EDA tool set. The EDA toolset may be one or more software programs comprised of multiple algorithms and designs for the purpose of generating a circuit design, testing the design, and/or placing the layout of the design in a space available on a target chip. The EDA toolset may include object code in a set of executable software programs. The set of application-specific algorithms and interfaces of the EDA toolset may be used by system integrated circuit (IC) integrators to rapidly create an individual IP core or an entire System of IP cores for a specific application. The EDA toolset provides timing diagrams, power and area aspects of each component and simulates with models coded to represent the components in order to run actual operation and configuration simulations. The EDA toolset may generate a Netlist and a layout targeted to fit in the space available on a target chip. The EDA toolset may also store the data representing the interconnect and logic circuitry on a machine-readable storage medium.

Generally, the EDA toolset is used in two major stages of SOC design: front-end processing and back-end programming. The EDA toolset can include one or more of a RTL generator, logic synthesis scripts, a full verification testbench, and SystemC models.

Front-end processing includes the design and architecture stages, which includes design of the SOC schematic. The front-end processing may include connecting models, configuration of the design, simulating, testing, and tuning of the design during the architectural exploration. The design is typically simulated and tested. Front-end processing traditionally includes simulation of the circuits within the SOC and verification that they should work correctly. The tested and verified components then may be stored as part of a stand-alone library or part of the IP blocks on a chip. The front-end views support documentation, simulation, debugging, and testing.

In block 1105, the EDA tool set may receive a user-supplied text file having data describing configuration parameters and a design for at least part of a interconnect and/or memory scheduler having tag logic. The data may include one or more configuration parameters for that IP block. The IP block description may be an overall functionality of that IP block such as an Interconnect, memory scheduler, etc. The configuration parameters for the Interconnect IP block and scheduler may include parameters as described previously.

The EDA tool set receives user-supplied implementation technology parameters such as the manufacturing process to implement component level fabrication of that IP block, an estimation of the size occupied by a cell in that technology, an operating voltage of the component level logic implemented in that technology, an average gate delay for standard cells in that technology, etc. The technology parameters describe an abstraction of the intended implementation technology. The user-supplied technology parameters may be a textual description or merely a value submitted in response to a known range of possibilities.

The EDA tool set may partition the IP block design by creating an abstract executable representation for each IP sub component making up the IP block design. The abstract executable representation models characteristics for each IP sub component and mimics characteristics similar to those of the actual IP block design. A model may focus on one or more behavioral characteristics of that IP block. The EDA tool set executes models of parts or all of the IP block design. The EDA tool set summarizes and reports the results of the modeled behavioral characteristics of that IP block. The EDA tool set also may analyze an application's performance and allows the user to supply a new configuration of the IP block design or a functional description with new technology parameters. After the user is satisfied with the performance results of one of the iterations of the supplied configuration of the IP design parameters and the technology parameters run, the user may settle on the eventual IP core design with its associated technology parameters.

The EDA tool set integrates the results from the abstract executable representations with potentially additional information to generate the synthesis scripts for the IP block. The EDA tool set may supply the synthesis scripts to establish various performance and area goals for the IP block after the result of the overall performance and area estimates are presented to the user.

The EDA tool set may also generate an RTL file of that IP block design for logic synthesis based on the user supplied configuration parameters and implementation technology parameters. As discussed, the RTL file may be a high-level hardware description describing electronic circuits with a collection of registers, Boolean equations, control logic such as “if-then-else” statements, and complex event sequences.

In block 1110, a separate design path in an ASIC or SOC chip design is called the integration stage. The integration of the system of IP blocks may occur in parallel with the generation of the RTL file of the IP block and synthesis scripts for that IP block.

The EDA toolset may provide designs of circuits and logic gates to simulate and verify the operation of the design works correctly. The system designer codes the system of IP blocks to work together. The EDA tool set generates simulations of representations of the circuits described above that can be functionally tested, timing tested, debugged and validated. The EDA tool set simulates the system of IP block's behavior. The system designer verifies and debugs the system of IP blocks' behavior. The EDA tool set tool packages the IP core. A machine-readable storage medium may also store instructions for a test generation program to generate instructions for an external tester and the interconnect to run the test sequences for the tests described herein. One of ordinary skill in the art of electronic design automation knows that a design engineer creates and uses different representations, such as software coded models, to help generating tangible useful information and/or results. Many of these representations can be high-level (abstracted and with less details) or top-down views and can be used to help optimize an electronic design starting from the system level. In addition, a design process usually can be divided into phases and at the end of each phase, a tailor-made representation to the phase is usually generated as output and used as input by the next phase. Skilled engineers can make use of these representations and apply heuristic algorithms to improve the quality of the final results coming out of the final phase. These representations allow the electric design automation world to design circuits, test and verify circuits, derive lithographic mask from Netlists of circuit and other similar useful results.

In block 1115, next, system integration may occur in the integrated circuit design process. Back-end programming generally includes programming of the physical layout of the SOC such as placing and routing, or floor planning, of the circuit elements on the chip layout, as well as the routing of all metal lines between components. The back-end files, such as a layout, physical Library Exchange Format (LEF), etc. are generated for layout and fabrication.

The generated device layout may be integrated with the rest of the layout for the chip. A logic synthesis tool receives synthesis scripts for the IP core and the RTL design file of the IP cores. The logic synthesis tool also receives characteristics of logic gates used in the design from a cell library. RTL code may be generated to instantiate the SOC containing the system of IP blocks. The system of IP blocks with the fixed RTL and synthesis scripts may be simulated and verified. Synthesizing of the design with Register Transfer Level (RTL) may occur. The logic synthesis tool synthesizes the RTL design to create a gate level Netlist circuit design (i.e. a description of the individual transistors and logic gates making up all of the IP sub component blocks). The design may be outputted into a Netlist of one or more hardware design languages (HDL) such as Verilog, VHDL (Very-High-Speed Integrated Circuit Hardware Description Language) or SPICE (Simulation Program for Integrated Circuit Emphasis). A Netlist can also describe the connectivity of an electronic design such as the components included in the design, the attributes of each component and the interconnectivity amongst the components. The EDA tool set facilitates floor planning of components including adding of constraints for component placement in the space available on the chip such as XY coordinates on the chip, and routes metal connections for those components. The EDA tool set provides the information for lithographic masks to be generated from this representation of the IP core to transfer the circuit design onto a chip during manufacture, or other similar useful derivations of the circuits described above. Accordingly, back-end programming may further include the physical verification of the layout to verify that it is physically manufacturable and the resulting SOC will not have any function-preventing physical defects.

In block 1120, a fabrication facility may fabricate one or more chips with the signal generation circuit utilizing the lithographic masks generated from the EDA tool set's circuit design and layout. Fabrication facilities may use a standard CMOS logic process having minimum line widths such as 1.0 um, 0.50 um, 0.35 um, 0.25 um, 0.18 um, 0.13 um, 0.10 um, 90 nm, 65 nm or less, to fabricate the chips. The size of the CMOS logic process employed typically defines the smallest minimum lithographic dimension that can be fabricated on the chip using the lithographic masks, which in turn, determines minimum component size. According to one embodiment, light including X-rays and extreme ultraviolet radiation may pass through these lithographic masks onto the chip to transfer the circuit design and layout for the test circuit onto the chip itself.

The EDA toolset may have configuration dialog plug-ins for the graphical user interface. The EDA toolset may have an RTL generator plug-in for the SocComp. The EDA toolset may have a SystemC generator plug-in for the SocComp. The EDA toolset may perform unit-level verification on components that can be included in RTL simulation. The EDA toolset may have a test validation testbench generator. The EDA toolset may have a dis-assembler for virtual and hardware debug port trace files. The EDA toolset may be compliant with open core protocol standards. The EDA toolset may have Transactor models, Bundle protocol checkers, OCPDis2 to display socket activity, OCPPerf2 to analyze performance of a bundle, as well as other similar programs.

As discussed, an EDA tool set may be implemented in software as a set of data and instructions, such as an instance in a software library callable to other programs or an EDA tool set consisting of an executable program with the software cell library in one program, stored on a machine-readable medium. A machine-readable storage medium may include any mechanism that provides (e.g., stores and/or transmits) information in a form readable by a machine (e.g., a computer). For example, a machine-readable medium may include, but is not limited to: read only memory (ROM); random access memory (RAM); magnetic disk storage media; optical storage media; flash memory devices; DVD's; EPROMs; EEPROMs; FLASH, magnetic or optical cards; or any other type of media suitable for storing electronic instructions. The instructions and operations also may be practiced in distributed computing environments where the machine-readable media is stored on and/or executed by more than one computer system. In addition, the information transferred between computer systems may either be pulled or pushed across the communication media connecting the computer systems.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In an embodiment, the logic consists of electronic circuits that follow the rules of Boolean Logic, software that contain patterns of instructions, or any combination of both. Various components described above may be implemented in hardware logic, software, or any combination of both.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The crossover structure and the logic associated with it are shown located in the initiator agent and the target agent which are considered to be part of the interconnect. Another architecture of this invention places the initiator agent and the target agent in the “system interface” of each initiator core and target core. The invention is to be understood as not limited by the specific embodiments described herein, but only by scope of the appended claims.

We claim:

1. An interconnect for an integrated circuit to communicate transactions between one or more initiator Intellectual Property (IP) cores and one or more target IP cores coupled to the interconnect, comprising:
tag logic within the interconnect configured to assign different interconnect tag identification numbers to two or more transactions from a same thread from a first multiple threaded initiator IP core to improve overall system performance by allowing the two or more transactions from the same thread of a first multiple threaded initiator IP core to be outstanding over the interconnect to two or more different target IP cores at the same time,
wherein the tag logic is further configured to allow the two or more transactions from the same thread to be processed in parallel over the interconnect and potentially serviced out of issue order while being returned back to the first multiple threaded initiator IP core realigned in expected execution order and eliminates any need for a re-order buffer per thread per initiator core, and wherein an interconnect tag identification number is used to link a response to a transaction with a thread generating the transaction that triggered the response from a first target IP core.

2. The interconnect for the integrated circuit of claim 1, wherein the tag logic in the interconnect internally tracks an issuance order of transactions from a given thread of a given IP core and assigns an interconnect tag id number for all transactions of that given thread that must be received back to that given IP core in their expected return order.

3. The interconnect for the integrated circuit of claim 1, wherein the tag logic is located in an agent interfacing an IP core to the remainder of the interconnect, and the tag logic includes one or more instances of a crossover storage structure, each crossover storage structure consisting of at least a CAM structure and a shared buffer pool structure, to allow assigning interconnect tag identification numbers with minimum area and logic because shared buffering of transactions with different interconnect tag identification numbers as well as different initiator IP core tag identification numbers occurs within the crossover storage structure.

4. The interconnect for the integrated circuit of claim 3, wherein one crossover storage structure exists per thread id and an instance of the crossover storage structure exists at both a target agent side of the interconnect and an initiator agent side of the interconnect.

5. The interconnect for the integrated circuit of claim 3, wherein each CAM entry row represents an interconnect tag id number that is potentially assigned to a currently outstanding transaction on the interconnect, and wherein each entry row of the CAM has many distinct fields including 1) an initiator IP core tag ID field to track a tuple of an initiator IP core tag id and a thread id associated with a series of transactions that share the same initiator IP core tag id and thread id, 2) an interconnect tag ID field to track an internal interconnect tag id assigned to the tuple of the initiator IP core tag id and a thread id, 3) a first pointer to point to an initial outstanding transaction of the series with the assigned internal interconnect tag id number from that tuple, and 4) a second pointer to point to a last outstanding transaction of the series with the assigned internal interconnect tag id number from that tuple, and upon receiving a new transaction the CAM stores the tuple of <initiator thread id, initiator IP core tag id> associated with the new transaction as a new CAM entry when a matching active tuple is not already stored in another CAM entry row.

6. The interconnect for the integrated circuit of claim 3, wherein each entry row of the CAM stores at least the initiator IP core thread id and two pointers, where the first pointer points to an initial outstanding transaction of the initiator IP core thread id that is assigned with a first internal interconnect tag id, and the second pointer points to a last outstanding transaction of the initiator IP core thread id with the assigned first internal interconnect tag id, and the cross over queue has just one entry for each transaction, including burst request transactions, as well as a burst field in the CAM stores a number of responses that still need to be generated for an outstanding burst transaction being tracked with the first internal interconnect tag id.

7. The interconnect for the integrated circuit of claim 1, wherein the tag logic is further configured to apply no ordering rules for transactions on different threads, while regulating that certain transactions with an assigned first internal interconnect tag id number from the same thread cannot be re-ordered or be allowed to be serviced before other interconnect tag id numbers when headed to the same target IP core.

8. The interconnect for the integrated circuit of claim 1, wherein the tag logic is further configured 1) to allow two transactions with the same thread id but different interconnect tag id numbers bound to different target agents can exit the interconnect in any order; however, two transactions with the same thread id but different interconnect tag id numbers headed to same target IP core, then the interconnect delivers those two transactions to the same target IP core in the order of arrival that those two transactions were launched onto the interconnect.

9. The interconnect for the integrated circuit of claim 1, wherein the tag logic is further configured 1) to require multiple transactions belonging to the same initiator tag id to have the responses for those transactions come back to an initiator agent in issuance order; however, 2) no limitations exist on a maximum number of open targets when initiator tag ids from the same thread of the same initiator IP core are different.

10. The interconnect for the integrated circuit of claim 3, wherein each CAM entry row contains at least pointers to the corresponding Buffer Pool entries to effectively create a linked list of Buffer Pool entries of tracked transactions per assigned internal interconnect tag id number and thus a linked list of transactions belonging to the same tag id without limiting the number of transactions per tag id, and
each row of the shared buffer pool has many distinct fields including fields to store the assigned interconnect tag ID number, the thread ID, outstanding transactions of the threads using this agent, pointers to a next transaction, and whether this transaction is a last transaction in the sequence.

11. The interconnect for the integrated circuit of claim 3, wherein each instance of the integrated circuit has a runtime user programmable parameter that allows a creator of that instance of the integrated circuit to set the CAM-based crossover storage structure size dependent on a maximum number of outstanding transactions/per thread at any given time at an agent containing the cross over queue structure, where the maximum number of outstanding transactions limit is set by the user, and thus, the user sets the size of the crossover storage structure at the agent based on the number of outstanding transactions/per thread that the associated IP core generates.

12. The interconnect for the integrated circuit of claim 3, wherein each instance of the integrated circuit has a runtime user programmable parameter that allows a creator of that instance of the integrated circuit to specify a maximum number of distinct interconnect tag id numbers per thread id that can be active at any instant for an agent containing the cross over queue structure, which then is used to generate an amount of possible entries of the CAM structure of the cross over queue structure.

13. The interconnect for the integrated circuit of claim 3, wherein each instance of the integrated circuit has a runtime user programmable parameter that allows a creator of that instance of the integrated circuit to specify a maximum number of outstanding transactions per thread that can be active on the interconnect from a given agent at any given point in time, across all of the tags on that thread, which then is used to generate a size of the buffer pool.

14. The interconnect for the integrated circuit of claim 1, wherein the tag logic is further configured 1) to support dynamic mapping of one tag id space to another tag id space as a transaction moves through the interconnect to allow allocation and de-allocation of internal interconnect tag numbering during the operation of the integrated circuit, and wherein the interconnect tag id space corresponds to an index of a CAM in a crossover storage structure and an initiator tag id space corresponds to a tag id assigned by an initiator IP core.

15. The interconnect for the integrated circuit of claim 1, wherein the tag logic is further configured 1) to support dynamic mapping of initiator IP core tag numbers to internal interconnect tag numbering during the operation of the integrated circuit, where an assigned internal interconnect tag id number is released for use again by the tag logic when a response from the target IP core corresponding to a last outstanding transaction of a series of transactions associated with a given thread ID and the assigned internal interconnect tag number issued by the initiator agent is received back by the initiator agent containing the crossover storage structure.

16. The interconnect for the integrated circuit of claim 1, wherein each instance of the integrated circuit has a runtime user programmable parameter that allows a creator of that instance of the integrated circuit to specify a setting of a mode switch that specifies the tag logic's mode of operation on a per-agent-thread basis, wherein the mode of operation is selectable based on the type of initiator IP cores in that instance and the type of target IP cores in that instance.

17. The interconnect for the integrated circuit of claim 1, further comprising:
a first target IP core that is a multiple channel aggregate target IP core with defined memory interleave segments, and the tag logic is further configured to permit multiple outstanding transactions to the same multi-channel aggregate target IP core by implementing interlock logic that eliminates an introduction of an out-of-order return of tagged responses within a given thread from the multiple channel aggregate target IP core.

18. The interconnect for the integrated circuit of claim 17 wherein the tag logic is configured to permit multiple outstanding transactions to the same multi-channel aggregate target IP core on different initiator agent tag numbers from a given thread, and the tag logic differentiates between channel-splitting requests verses non-channel-splitting requests of a transaction headed to the multi-channel aggregate target IP core, and the tag logic is further configured to 1) enforce a restriction of a single open logical target rule per same initiator agent tag per thread for non-channel-splitting requests being routed to the multi-channel target IP core, 2) permit multiple non-channel-splitting requests on different initiator agent tags in a given thread to be outstanding because the crossover storage structure can handle out-of-order return of responses among tags, 3) permit at most one outstanding channel-splitting request per thread, and wherein channel-splitting requests, on the other hand, by definition go to multiple physical targets making up the multiple channel aggregate target IP core at the same time.

19. The interconnect for the integrated circuit of claim 3, wherein the tag logic is further configured to support different types of tags, including Compact Tags, Partially Compact Tags, and Pass Through Tags to alter an allocation and a de-allocation operation of assigning internal interconnect tag id number to a thread from the crossover storage structure.

20. A machine-readable storage medium that stores instructions, which when executed by the machine causes the machine to generate model representations for the interconnect of claim 1, which are used in the Electronic Design Automation process.

21. A method of routing transactions over an interconnect for an Integrated Circuit between one or more initiator IP cores and one or more target IP cores including one or more multiple channel aggregate target IP cores coupled to the interconnect, comprising:
routing a first transaction, from a first thread from a first initiator IP core to a first multiple channel aggregate memory target IP core, in which transaction traffic consists of both non-channel-splitting requests and channel-splitting requests, and wherein a first multiple channel aggregate memory target IP core includes two or more memory channels that populate an address space assigned to the first multiple channel aggregate memory target IP core, and the first multiple channel aggregate memory target IP core appears as a single target to the one or more initiator IP cores;
assigning with tag logic located within the interconnect a first interconnect tag id number to a first transaction and a second interconnect tag id number to a second transaction from a first thread from a first initiator IP core being routed to the first multiple channel aggregate memory target IP core; and
detecting whether a request of the first transaction from the first thread spans over at least a first and second memory channel in the first multiple channel aggregate memory target IP core and applying interlocks via the tag logic within the interconnect, so that in terms of correctness, all of the responses of the first transaction and second transaction are routed back across the interconnect to the first initiator IP core in the expected execution order.

22. An Integrated Circuit, comprising:
multiple initiator IP cores;
multiple target IP cores including memory IP cores;
an interconnect to communicate transactions between the multiple initiator IP cores and the multiple target IP cores coupled to the interconnect; and
tag logic located within an agent of the interconnect configured to support dynamic mapping of one tag id space to another tag id space as a transaction moves through the interconnect to allow allocation and de-allocation of internal interconnect tag id numbering during the operation of the integrated circuit, where an assigned internal interconnect tag id number is released for use again by the tag logic when a response, from a given target IP core, corresponding to a last outstanding transaction of a series of transactions associated with both 1) a given thread ID and 2) the assigned internal interconnect tag id number issued by the initiator agent is received back by the initiator agent containing the tag logic that assigned the internal interconnect tag id number.
